(19) United States
(12) Patent Application Publication
(10) Pub. No.: US 2009/0260017 A1
(43) Pub. Date: Oct. 15, 2009

(54) WORKFLOW EXECUTION DEVICE AND WORKFLOW EXECUTION METHOD

(75) Inventor: Toru Yoshida, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/423,705

(22) Filed: Apr. 14, 2009

(30) Foreign Application Priority Data
Apr. 15, 2008 (JP) 2008-106071

(51) Int. Cl. G06F 9/46

(52) U.S. Cl. 718/105

(57) ABSTRACT

A workflow execution device is provided. The latest update date information relating to date when update is performed is added to each step of a workflow definition file. When executing each step of the workflow definition file, processing execution date information relating to date when the execution is performed is added to data processed. Subsequently, when executing each step of the workflow definition file, the final processing date of the data is determined from the processing execution date information added to the data processed. In a case where the update date determined from the latest update date information prior to the execution is later than the final processing date of the data to be processed in the execution, the processing in the execution is cancelled.

### BACKGROUND OF THE INVENTION

1. Field of the Invention

The present invention relates to a workflow execution device, workflow execution method, and computer program, and specifically, the present invention is preferably employed for executing a workflow.

2. Description of the Related Art

In recent years, there has been studied and proposed performing of workflow processing such as office work or the like by employing a digital multifunction printer. For example, with a digital multifunction printer, an arrangement has been conceived wherein an application form is digitized and transmitted to a server which manages a workflow, so as to be input to workflow processing, or a job being processed is obtained from the workflow server to perform print processing, or the like. The digital multifunction printer has a function for digitizing paper to transmit the data on the paper thereof by employing one of multiple communication protocols, and a function for obtaining data to execute printing. Examples of communication protocols include an SMTP (Simple Mail Transfer Protocol), and FTP (File Transfer Protocol).

Employing such a function enables the digital multifunction printer to execute processing such as described above. Japanese Patent Laid-Open No. 2004-265140 has disclosed a method for enabling electronic filing of documents and paper documents to be mixed within a workflow, and so forth. Specifically, with Japanese Patent Laid-Open No. 2004-265140, first, a workflow server instructs a digital multifunction printer to add unique ID information which a scanner can read to a paper document to print this. A printer included in the digital multifunction printer prints the paper document to which the ID information is added based on this instruction. Subsequently, upon a scanner included in the digital multifunction printer scanning the paper document to which the ID information is added, the workflow server processes the ID information and paper document information thereof to execute an assessment and approval flow of an electronic filing document. Thus, electronic filing documents and paper documents can be mixed within the assessment and approval flow.

Also, Japanese Patent Laid-Open No. 2007-27861 has disclosed a digital multifunction printer including a workflow engine capable of execution of workflow specifications. The digital multifunction printer according to Japanese Patent Laid-Open No. 2007-27861 includes an input/output interface according to workflow specifications, and a management unit according to workflow specifications. The digital multifunction printer receives the workflow specifications (processing procedure) from the workflow server through the Internet, and determines, of the work flow specifications thereof, a portion in charge to be processed by the own workflow engine, and executes the processing of the portion in charge thereof. Thus, a technique has been disclosed wherein a workflow server and digital multifunction printer collaborate to perform workflow processing at the digital multifunction printer. Such a technique is premised on that there is a server which manages the job state of a workflow, and flow definitions, such as a workflow server.

There has been disclosed a method for realizing simple workflow processing by the functions of a digital multifunction printer collaborating. There has been disclosed a method wherein a workflow definition file for performing processing is stored in a digital multifunction printer, and in a case where a particular button is pressed by a user, the digital multifunction printer executes a series of processing in accordance with the workflow definition. A series of processing is described in a workflow definition file, such that the digital multifunction printer scans an application form, converts the data of the scanned application form into an electronic filing document such as a PDF or the like, and transmits (stores) this to (in) a particular file server, and informs a particular user of the results thereof by mail. Subsequently, in the case of receiving an instruction to execute the processing defined in the workflow definition file, the digital multifunction printer interprets the content of the workflow definition file thereof to execute this.

Such a case has implications that providing a workflow server or the like is not imperative, and a function flow of the digital multifunction printer rather than a workflow is defined in a workflow definition file, thereby realizing a simple flow. In such a case, the processing is completed with a series of function flow of the digital multifunction printer, so there is no need to collaborate with other processing, and accordingly, there is no need to manage the workflow (the state of a job) such as the above-mentioned server.

However, with such a method, in a case where there is no workflow server, only simple processing can be realized where the functions of the digital multifunction printer collaborate, and accordingly, flows which can be realized are restricted. In order to execute workflow processing in which multiple processes are connected, a job being processed has to be managed punctually, otherwise in a case where a workflow definition is updated, modified, or deleted, appropriate processing is not performed. Thus, with the related art, if there is no server which manages a job to be executed in a workflow, it is difficult to execute a complicated workflow.

### SUMMARY OF THE INVENTION

According to an embodiment of the present invention, a workflow execution device configured to execute, based on a workflow definition file in which the contents of processes within a workflow, and process content update time, which is time when the content of at least one of the processes was updated, are set. The processes of the workflow include an adding unit configured to add, upon processing in accordance with the content of the process of the workflow being executed, process execution time which is time when the processing in accordance with the content of the process was executed to data obtained by execution of the processing in accordance with the content of the process. The process of the workflow also includes a first obtaining unit configured to obtain the process content update time from the workflow definition file at the time of executing the processing in accordance with the content of the process of the workflow; a second obtaining unit configured to obtain the process execution time added to data employed for the processing in accordance with the content of the process to be executed, by the adding unit; and a canceling unit configured to cancel execution of the processing in accordance with the content of the process to be executed when the process content update time obtained by the first obtaining unit is later than the process execution time obtained by the second obtaining unit.

Other features and advantages of the present invention will be apparent from the following description taken in conjunction with the accompanying drawings, in which like reference characters designate the same or similar parts throughout the figures thereof.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a first embodiment of the present invention, and illustrating an example of the entire configuration of a workflow processing system.

FIG. 2 is a block diagram illustrating the first embodiment of the present invention, and illustrating an example of the configuration of an image forming apparatus.

FIG. 3 is a block diagram illustrating the first embodiment of the present invention, and illustrating an example of the functional configuration of workflow processing software executed at the image forming apparatus.

FIG. 4 is a diagram illustrating the first embodiment of the present invention, and illustrating an example of the external configuration of an operating unit of the image forming apparatus.

FIGS. 5A and 5B are diagrams illustrating the first embodiment of the present invention, wherein FIG. 5A illustrates an example of the external configuration of a key input portion in detail, and FIG. 5B illustrates an example of the external configuration of a touch panel portion in detail.

FIG. 6 is a flowchart illustrating the first embodiment of the present invention, and describing an example of the processing of the image forming apparatus in a case where print processing is executed with workflow processing.

FIG. 7 is a flowchart illustrating the first embodiment of the present invention, and describing an example of the processing of the image forming apparatus in a case where scan processing is executed with the workflow processing.

FIG. 8 is a diagram illustrating the first embodiment of the present invention, and illustrating an example of a screen displayed on the touch panel portion for executing the workflow processing software.

FIG. 9 is a diagram illustrating the first embodiment of the present invention, and illustrating a written example of a workflow definition file of the workflow.

FIG. 10 is a flowchart illustrating the first embodiment of the present invention, and describing an example of the processing of the workflow processing software.

FIG. 11 is a diagram illustrating the first embodiment of the present invention, and illustrating an example of a workflow definition file after the template of a purchase application form has been modified.

FIG. 12 is a diagram illustrating the first embodiment of the present invention, and illustrating an example of a workflow definition file after the workflow has been modified.

FIG. 13 is a diagram illustrating a second embodiment of the present invention, and illustrating an example of a workflow definition file.

FIG. 14 is a flowchart illustrating the second embodiment of the present invention, and describing an example of the processing of workflow processing software.

FIG. 15 is a flowchart illustrating a third embodiment of the present invention, and describing an example of the processing of workflow processing software.

FIG. 16 is a diagram illustrating the third embodiment of the present invention, and illustrating an example of the entire configuration of a workflow processing system.

FIG. 17 is a flowchart illustrating the third embodiment of the present invention, and describing an example of the processing of workflow processing software.

FIG. 18 is a block diagram illustrating the third embodiment of the present invention, and illustrating an example of the functional configuration of workflow processing software executed at the image forming apparatus.

FIG. 19 is a diagram illustrating the third embodiment of the present invention, and illustrating an example of a table which stores job information managed at a workflow management server.

### DESCRIPTION OF THE EMBODIMENTS

Various embodiments of the present invention will now be described in detail in accordance with the accompanying drawings.

A first embodiment of the present invention will be described below with reference to the drawings. System Configuration

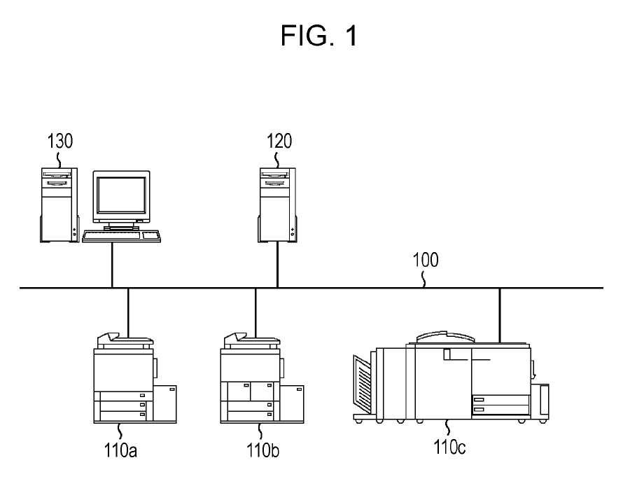

FIG. 1 is a diagram illustrating an example of the entire configuration of a workflow processing system. In FIG. 1, the workflow processing system includes image forming apparatuses 110a, 110b, and 110c, mail server 120, and file server 130. The image forming apparatuses 110a, 110b, 110c, mail server 120, and file server 130 are connected mutually in a communicable manner through a network 100. Note that FIG. 1 illustrates a case where three image forming apparatuses 110 are provided in the workflow processing system as an example, and the number of the image forming apparatuses 110 is not restricted to this.

The image forming apparatuses 110 are, for example, digital multifunction printers (MFP). The image forming apparatuses 110 have a function for holding a workflow definition file in which a workflow definition is described, and a function for interpreting the content of a workflow definition described in the held workflow definition file. Further, the image forming apparatuses 110 have a function for executing the specified workflow processing based on the interpreted workflow definition. Additionally, the image forming apparatuses 110 have a scan function for scanning paper originals, print function for printing data, transmission/reception function for transmitting/receiving data (fax function or the like), saving function for saving data, and editing function for performing operations of data. The scan function has a function for extracting processing date information printed on the scanned paper original, or processing date information embedded in the scanned paper original. The print function has a function for printing or embedding the information of the processing date when workflow processing has been performed on or in a paper original. Further, the transmission/reception function, save function, and editing function have a function for setting the processed data to the information of the processing date when the workflow processing was executed. The mail server 120 and file server 130 are each known servers having common functions.

### Configuration of Image Forming Apparatus

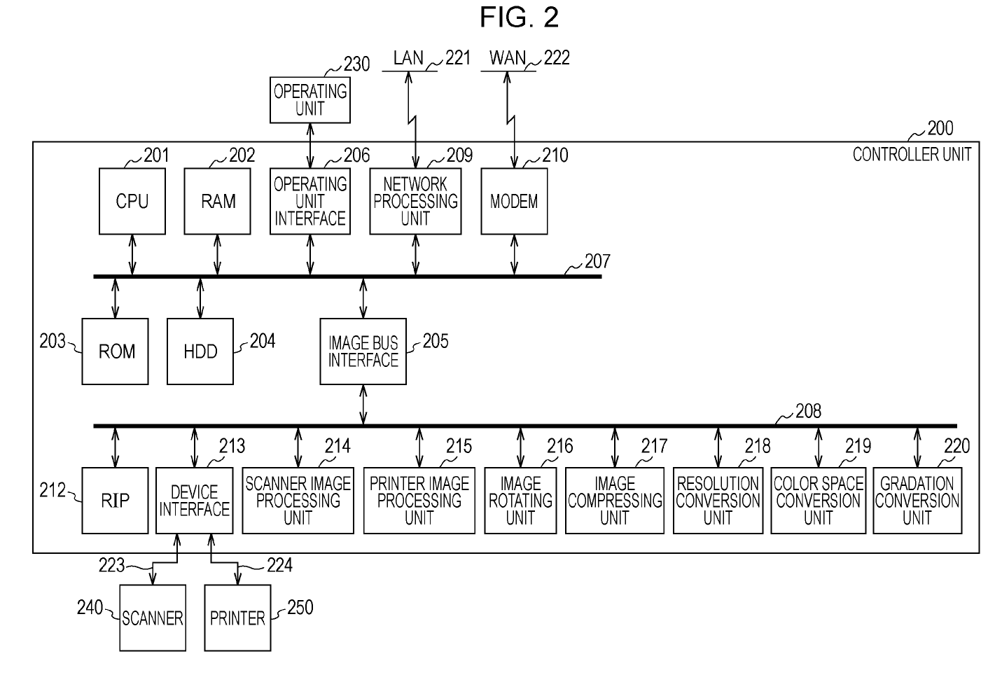

FIG. 2 is a block diagram illustrating an example of the configurations of the image forming apparatuses 110. A controller unit 200 is a controller for performing input/output of image information and device information. The controller unit 200 is mutually connected with a scanner 240 which is an image input device, and a printer 250 which is an image output device. Also, the controller unit 200 is also mutually connected with a LAN 221 and WAN (public line) 222. A CPU 201 is a controller for controlling the entire system of the image forming apparatus 110. RAM 202 is system work memory for the CPU 201 operating, and is also image memory for storing image data temporarily. ROM 203 is a boot ROM, and stores a boot program of the system of the image forming apparatus 110.

An HDD 204 is a hard disk drive, and stores system software, image data, workflow definition file, and so forth. An operating unit interface 206 becomes an interface with an operating unit (UI) 230, and outputs image data to be displayed on the operating unit 230 to the operating unit 230. Also, the operating unit interface 206 informs the CPU 201 of information input by the user of the image forming apparatus 110 operating the operating unit 230. A network processing unit 209 is connected to the LAN 221 mutually, and performs input/output of information as to an external device through the LAN 221. A modem 210 is mutually connected with the WAN 222, and performs input/output of information as to an external device through the WAN 222. The above-mentioned devices are disposed on a system bus 207. An image bus interface 205 is a bus bridge for mutually connecting the system bus 207 and an image bus 208 for transferring image data at high speed to convert a data structure. The image bus 208 is configured of a PCI bus or IEEE1394. The above-mentioned devices are disposed on the image bus 208.

A raster image processor (RIP) 212 renders a PDL record into a bitmap image. A device interface 213 mutually connects the scanner 240, printer 250, and controller unit 200 which are image input/output devices to perform conversion of synchronizing system/asynchronous system of image data. A scanner image processing unit 214 subjects image data input from the scanner 240 or the like to correction, processing, or editing. Also, the scanner image processing unit 214 determines whether the image data input from the scanner 240 or the like is which data of a color original or monochrome original based on the chroma signal of the image data to hold the results thereof.

A printer image processing unit 215 subjects the image data to be output to the printer 250 or the like to correction, processing, or editing. Simultaneously with reading out the image data input from the scanner 240, an image rotating unit 216 collaborates with the scanner image processing unit 214 to rotate the image data, and stores this in memory. Also, the image rotating unit 216 can rotate an image held in memory to store this in the memory, or can collaborate with the printer image processing unit 215 to print out image data held in memory while rotating the image data thereof.

A resolution conversion unit 218 converts the resolution of image data held in memory to store this in the memory. A color space conversion unit 219 converts, for example, a YUV image held in memory into a Lab image by a matrix calculation to store this in the memory. A gradation conversion unit 220 converts, for example, 8-bit image data with 256 gradations held in memory into 1-bit image data with two gradations by a method such as error diffusion processing or the like to store this in the memory. An image compressing unit 217 subjects multi-value image data to compression/decompression in accordance with JPEG, and subjects binary image data to compression/decompression in accordance with JBIG, MMR, MR, or MH, for example. The image rotating unit 216, resolution conversion unit 218, color space conversion unit 219, gradation conversion unit 220, and image compressing unit 217 can operate by being connected each. For example, in a case where image data held in memory is subjected to rotation and resolution conversion, such processing can be performed without going through memory.

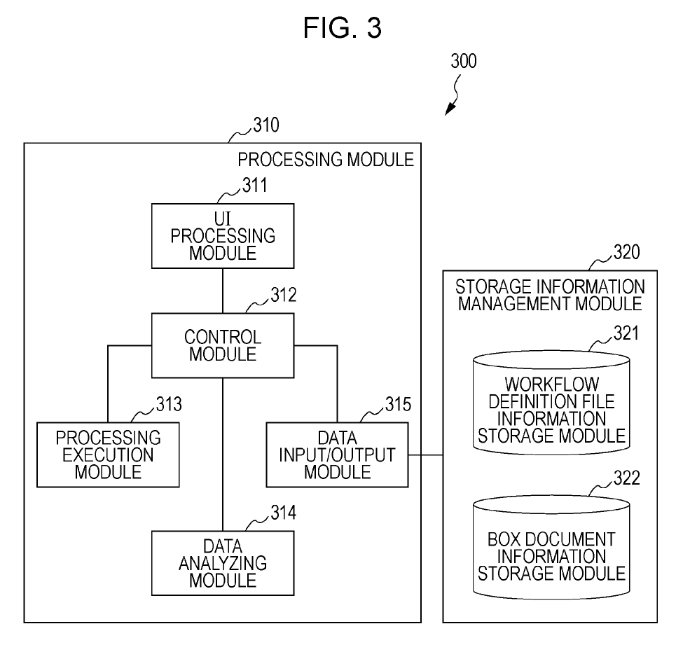

FIG. 3 is a block diagram illustrating an example of the functional configuration of workflow processing software executed at the image forming apparatuses 110. This workflow processing software (application program) is stored in the HDD 204, rendered in the RAM 202, and executed by the CPU 201. In FIG. 3, workflow processing software 300 principally includes a processing module 310 and storage information management module 320. The processing module 310 includes a UI processing module 311, control module 312, processing execution module 313, data analyzing module 314, and data input/output module 315.

The UI processing module 311 receives the information from the operating unit 230 through the operating unit interface 206. Also, the UI processing module 311 transmits information to the operating unit 230. The data input/output module 315 manages input/output of data performed between the processing module 310 and storage information management module 320. The data analyzing module 314 performs analyzing of a workflow definition file, analyzing of data scanned by the scanner 240, and so forth. The processing execution module 313 performs processing such as workflow processing and so forth. The control module 312 controls such processing performed at the UI processing module 311, processing execution module 313, data analyzing module 314, and data input/output module 315.

The storage information management module 320 manages a workflow definition file information storage module 321, and box document information storage module 322. The workflow definition file information storage module 321 stores workflow definition file information which is the information of a workflow definition file. On the other hand, the box document information storage module 322 stores box information which is information of a box and document within a box, in a recording medium. The data entities of the workflow definition file information and box information are stored in, for example, the HDD 204.

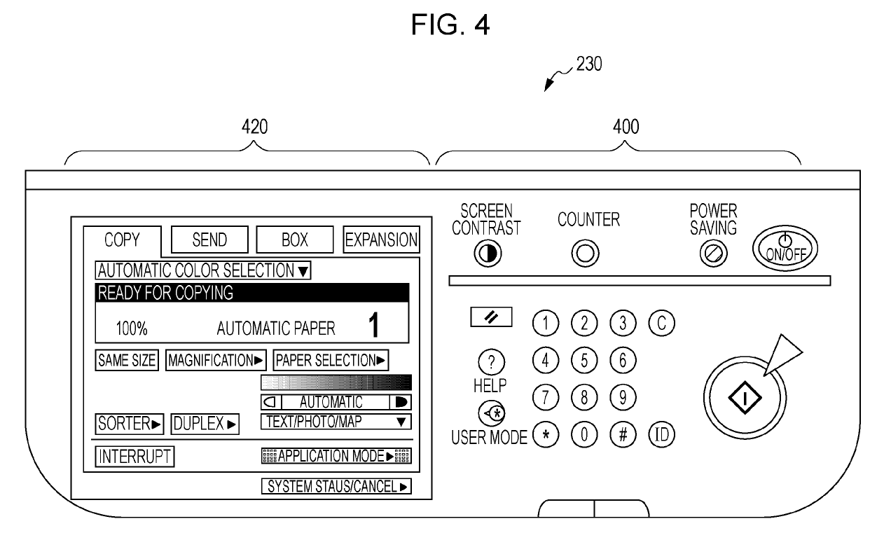

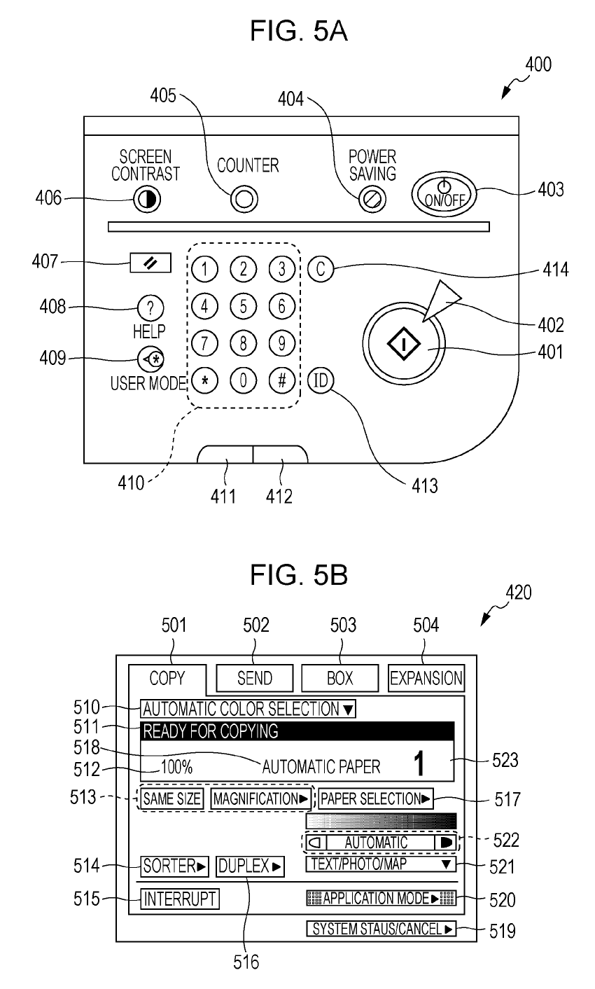

FIG. 4 is a diagram illustrating an example of the external configuration of the operating unit 230 of the image forming apparatus 110. Note that FIG. 4 schematically illustrates the external configuration of the operating unit 230 for convenience of explanation. In FIG. 4, the operating unit 230 includes a key input portion 400, and touch panel portion 420. FIG. 5A is a diagram illustrating a detailed example of the external configuration of the key input portion 400, and FIG. 5B is a diagram illustrating a detailed example of the external configuration of the touch panel portion 420. The key input portion 400 shown in FIG. 5A is the input portions of keys which allow the user to perform routine operations and settings. An operating unit power switch 403 is a switch operated by the user to switch a standby mode and sleep mode. In a state in which a main power switch for performing power supply of the entire system of the image forming apparatus 110 is ON, the control based on the operations of the operating unit power switch 403 can be performed. Now, the standby mode is a normal operation state. The sleep mode is an interruption-waiting state in which the controller unit 200 waits for network print, facsimile, or the like, i.e., in a state in which the controller unit 200 stops execution of the program, and suppresses power consumption.

A power saving key 404 is a key operated by the user to decrease the control temperature of a fixer in the standby mode. Upon the power saving key 404 being operated, it takes time to become a printable state, but power consumption can be suppressed. Note that the control temperature of the fixer can be reduced by setting a power saving rate. A start key 401 is a key operated by the user to instruct start of copying, transmission, or the like, and a stop key 402 is a key operated by the user to instruct discontinuation of copying, transmission, or the like.

A numeric keypad 410 is made up of keys operated by the user to give the substituted numbers of various types of settings for the image forming apparatus 110. A clear key 414 is a key operated by the user to cancel the substituted numbers. An ID key 413 is a key to have the user input a predetermined password to authenticate the user of the image forming apparatus 110. A reset key 407 is a key operated by the user to invalidate various types of settings of the image forming apparatus 110 to return the settings to a default state. A help key 408 is a key operated by the user to display guidance or help on the touch panel portion 420. A user mode key 409 is a key operated by the user to proceed to the system setting screen for each user.

A counter confirming key 405 is a key operated by the user to display the number of output sheets stored in a software counter, which counts the number of printed sheets and so forth, provided within the image forming apparatus 110 on the touch panel portion 420. With the image forming apparatus 110 according to the present embodiment, each of the number of output sheets can be displayed on the touch panel portion 420 according to the operation mode such as copy, print, scan, fax, or the like, color mode such as color or monotone, paper size such as large or small, or the like. An image contrast dial 406 is a dial operated by the user to adjust the ease of viewing a screen by adjusting the backlight of liquid crystal display of the touch panel portion 420, or the like.

An execution/memory lamp 411 blinks when a job is being executed, and when memory is being accessed, and is a lamp to inform the user of these. An error lamp 412 blinks in a case where a job cannot be executed, a case where an error occurs such as a service man call or the like, or a case where an operator call or the like occurs to inform the user of jamming, lack of consumables, or the like, and is a lamp to inform the user of such a case.

The touch panel portion 420 shown in FIG. 5B includes a LCD (Liquid Crystal Display) and a “touch panel display including a transparent electrode” adhered onto the LCD. Upon the user touching the transparent electrode which is a portion equivalent to a key displayed on the LCD by a finger, the touch panel portion 420 detects this, and performs various types of display in accordance with the detected content and the content programmed beforehand, such that another operating screen is displayed, or the like. FIG. 5B illustrates an example of an initial screen in the standby mode. According to the setting operations by the user as to this initial screen, the touch panel portion 420 can display various types of operating screens.

A copy tab 501 is a tab key operated by the user to proceed to an operating screen for copy operation. A transmission tab 502 is a tab key operated by the user to proceed to an operating screen for instructing transmission (send) operation, such as fax, e-mail transmission, or the like. A box tab 503 is a tab key operated by the user to proceed to a screen for inputting/outputting a job to a box (storage unit for storing a job for each user). An option tab 504 is a tab key operated by the user to add or set an expansion function such as scanner settings, workflow processing function, or the like. A system monitor key 519 is a key operated by the user to display the state or situation of the image forming apparatus 110. The user can proceed to the operating mode of the image forming apparatus 110 corresponding to each tab by selecting each tab.

A color selection setting key 510 is a key operated by the user to select color copy, monochrome copy, or automatic selection beforehand. A magnification setting key 513 is a key operated by the user to proceed to a screen for performing magnification setting such as the same size, enlargement, reduction, or the like. A post-processing setting key 514 is a key operated by the user to proceed to a screen for setting the presence/absence, number, and position of the post-processing, such as stapling, punching, or the like. A duplex setting key 516 is a key operated by the user to proceed to a screen for selecting simplex printing or duplex printing. A paper size setting key 517 is a key operated by the user to proceed to a screen for selecting a paper feed tray, paper size, and media type. An image mode setting key 521 is a key operated by the user to select an image mode suitable for an original image, such as text mode, photo mode, or the like. A density setting key 522 is a key operated by the user to adjust an output image to be denser or lighter.

A status display portion 511 is a display portion for performing simple state display such as a standby state, under a warm-up, jamming, error, or the like. A magnification display portion 512 is a display portion for displaying the magnification set by the magnification setting key 513. A paper size display portion 518 is a display portion for displaying the paper size or mode set by the paper size setting key 517. A number-of-sheets display portion 523 is a display portion for displaying the number of sheets specified by the numeric keypad 410, or displaying which sheet is printing during operation. Further, an interruption key 515 is a key operated by the user in a case where another job is interrupted during copying. An application mode key 520 is a key operated by the user to proceed to a screen for performing various image processing, layout setting, or the like, such as continuous page shooting, cover and interleaving paper settings, reduction layout, image movement, or the like.

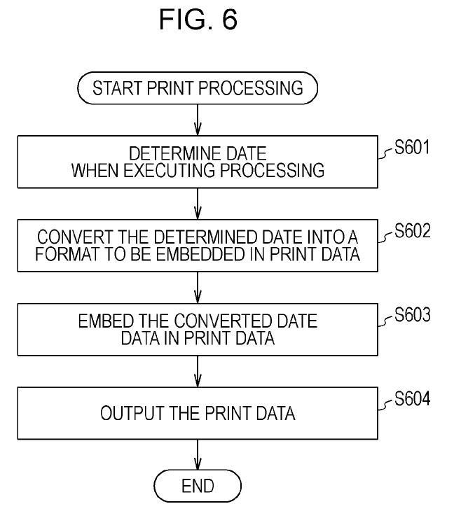

FIG. 6 is a flowchart for describing an example of the processing of the image forming apparatus 110 in a case where print processing is executed with the workflow processing. First, in step S601, the control module 312 and processing execution module 313 determine processing execution date (the current date when the processing is executed). Next, in step S602, the processing execution module 313 converts the date determined in step S601 into a data format which can be embedded in print data to be printed. For example, in step S602, the date determined in step S601 is converted into data such as two-dimensional barcode or the like including the date information determined in step S601.

Next, in step S603, the processing execution module 313 embeds the data converted in step S602 in print data to be printed (e.g., a portion equivalent to a lower right portion of the sheet). Here, in a case where data has been disposed in the corresponding portion within the print data to be printed, the processing execution module 313 deletes the already-disposed data, and embeds the data converted in step S602. Subsequently, in step S604, the control module 312 outputs the print data thereof to the printer image processing unit 215 through the image bus interface 205. The printer image processing unit 215 collaborates with the image rotating unit 216 or the like as necessary to subject the print data thereof to processing, and outputs the print data subjected to processing to the printer 250 through the device interface 213. Subsequently, the printer 250 performs printing based on the input print data. Thus, the processing according to the flowchart in FIG. 6 is ended.

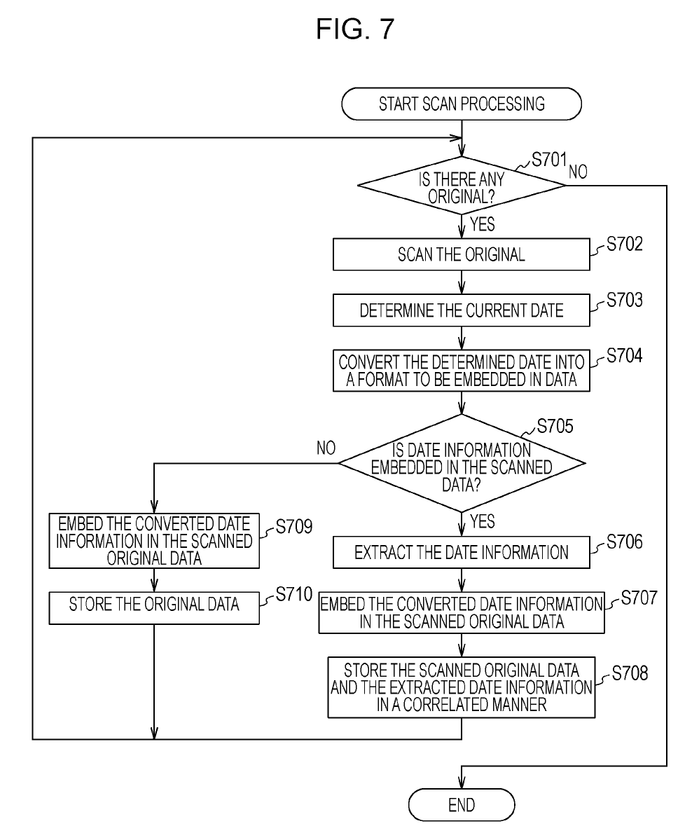

FIG. 7 is a flowchart for describing an example of the processing of the image forming apparatus 110 in a case where scan processing is executed with the workflow processing. First, in step S701, the control module 312 and processing execution module 313 determine whether or not there is any original to be scanned on the scanner 240. As a result of this determination, in a case where there is no original on the scanner 240, the processing according to the flowchart in FIG. 7 is ended. In a case where there is an original on the scanner 240, the flow proceeds to step S702. Upon proceeding to step S702, the scanner 240 scans the original. Subsequently, the data analyzing module 314 analyzes the data of the original scanned at the scanner 240. Next, in step S703, the processing execution module 313 determines the current date. Next, in step S704, the processing execution module 313 converts the date information determined in step S703 into a data format which can be embedded in the data scanned in step S702.

Next, in step S705, the processing execution module 313 determines whether or not date information is embedded in the data of the original scanned in step S702 based on the results analyzed in step S702. As a result of this determination, in a case where date information is embedded in the data of the original, the flow proceeds to later-described step S706. In a case where no date information is embedded in the data of the original, the flow proceeds to step S709. Upon proceeding to step S709, the processing execution module 313 embeds the date information converted in step S704 in the data of the original scanned in step S702. Next, in step S710, the data input/output module 315 stores the data of the original in which the date information has been embedded in step S709 in the box document information storage module 322. Subsequently, the processing returns to step S701.

In a case where determination is made in step S705 that date information is embedded in the data of the original, the flow proceeds to step S706, where the processing execution module 313 extracts the embedded date information. Next, in step S707, the processing execution module 313 deletes the date information already embedded in the data of the original, and then embeds the date information converted in step S704 in the data of the original scanned in step S702.

Next, in step S708, the processing execution module 313 correlates the date information extracted in step S706 with the data of the original scanned in step S702. Subsequently, the data input/output module 315 temporarily stores these in the box document information storage module 322. Subsequently, the processing returns to step S701.

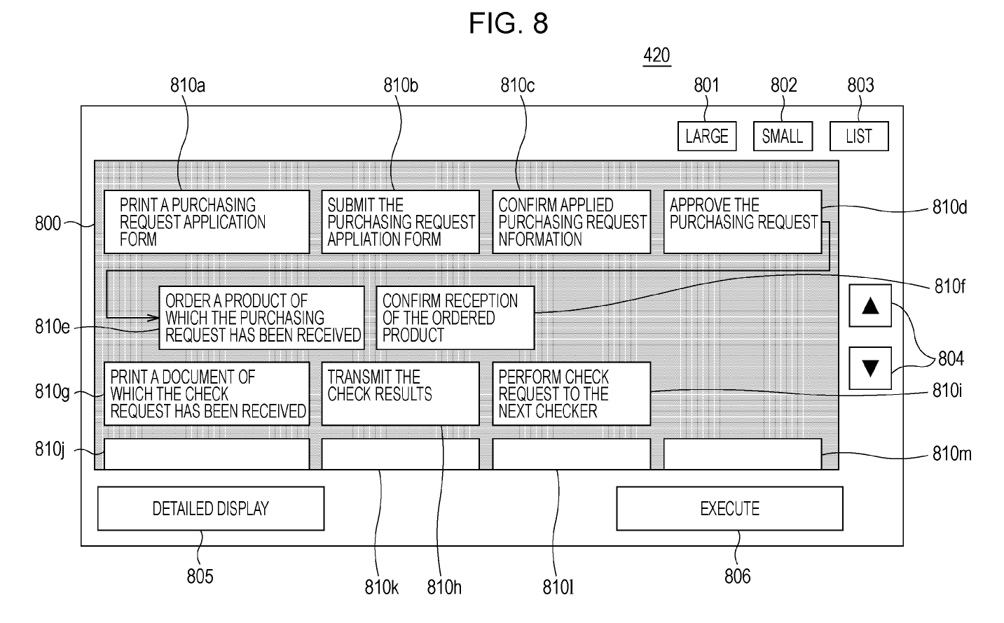

FIG. 8 is a diagram illustrating an example of a screen displayed on the touch panel portion 420 for executing the workflow processing software 300. Upon the user selecting the option tab 504 shown in FIG. 5B, the UI processing module 311 of the workflow processing software 300 returns the response as to this to the operating unit 230, whereby the screen shown in FIG. 8 is created. Upon the UI processing module 311 receiving inquiry regarding display content from the operating unit 230, the data input/output module 315 extracts the information of each step of the workflow stored in the workflow definition file information storage module 321. Subsequently, the UI processing module 311 defines workflow processing execution buttons 810 for executing the processing of each workflow displayed within a workflow definition display region 800 based on the information extracted at the data input/output module 315, and returns display data to the operating unit 230.

Respective buttons 801 through 803 on the upper right of the screen shown in FIG. 8 are buttons for switching the display method of the workflow processing execution buttons 810 displayed on the workflow definition display region 800. In the case of the user selecting the large button 801, the workflow processing execution buttons 810 are displayed with large buttons such as shown in FIG. 8. In the case of the user selecting the small button 802, the workflow processing execution buttons 810 are displayed with buttons smaller than shown in FIG. 8. In the case of the user selecting the list button 803, the contents of the workflow processing execution buttons 810 are displayed with a list form. Also, upon the user selecting an up/down button 804, the content displayed within the workflow definition display region 800 is scrolled upward or downward. Upon the user selecting a detailed display button 805 in a state in which the workflow processing execution button 810 is selected, the details of the processing content of the selected workflow processing execution button 810 are displayed on the screen. Also, upon the user pressing an execution button 806 while selecting the workflow processing execution button 810, execution of the workflow processing corresponding to the selected workflow processing execution button 810 is started.

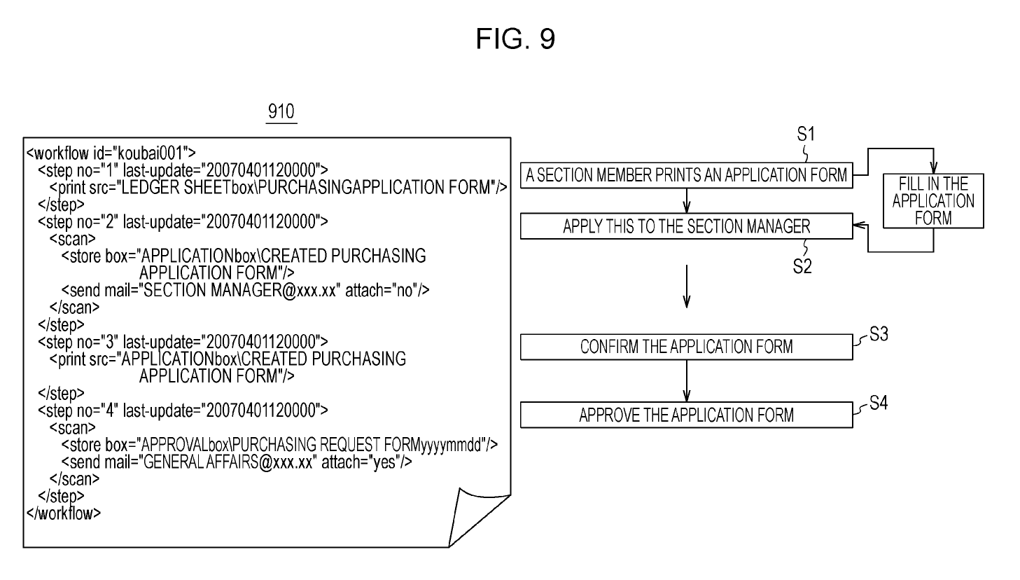

With the present embodiment, the details of each process of the workflow will be described by exemplifying a workflow wherein a section member prints and fills in a purchasing request application form, files this to the section manager, and the section manger approves the application form thereof. FIG. 9 is a diagram illustrating a written example of the workflow definition file of the workflow according to the present embodiment. The workflow defined with this workflow definition file 910 is made up of processes of steps S1 through S4. As shown in FIG. 9, with the present embodiment, the workflow definition file 910 is a structured document indicating information with tags, wherein the processing content of each step (each process) is written with a “step” tag. With the processing of each step, “last-update” is written as the final update date of each step. Note that the workflow definition file 910 is, for example, a file created by an external device beforehand.

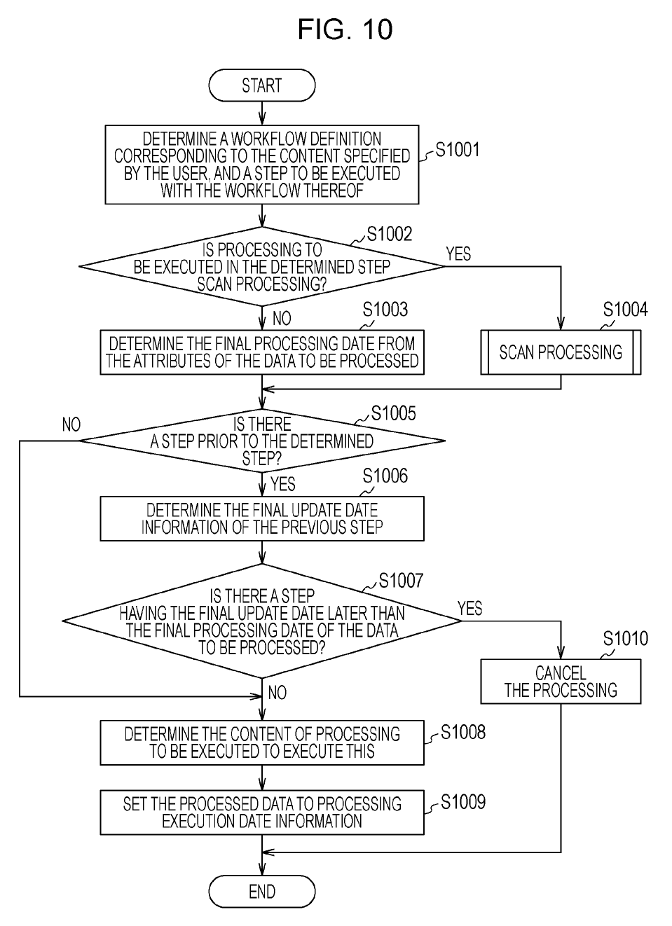

FIG. 10 is a flowchart describing an example of processing of the workflow processing software 300 in a case where the user has selected the workflow processing execution button 810, and has selected the execute button 806. Upon the user instructing workflow processing, the UI processing module 311 receives the content of this instruction. First, in step S1001, the data input/output module 315 searches “the content of the user's instruction” received at the UI processing module 311 from the workflow definition file information storage module 321. Subsequently, the data input/output module 315 determines, based on the search results, the workflow definition corresponding to the workflow processing specified by the user, and the information of a step to be executed from the workflow thereof (any information of steps S1 through S4 in the example shown in FIG. 9).

Next, in step S1002, the processing execution module 313 determines from the information of the step determined in step S1001 whether or not the processing to be executed is the scan processing. As a result of this determination, in a case where the processing to be executed is the scan processing, the flow proceeds to step S1004, where the processing execution module 313 executes all or a part of the scan processing described in FIG. 7 (e.g., steps S701 through S706). Subsequently, the flow proceeds to step S1005. In a case where the processing to be executed is not the scan processing, the flow proceeds to step S1003. Upon proceeding to step S1003, the data input/output module 315 searches data to be subjected to processing from the box document information storage module 322. Subsequently, the processing execution module 313 determines from “the data to be subjected to processing” searched at the data input/output module 315 (e.g., attribute information) the final processing date of the data to be subjected to processing thereof. Subsequently, the flow proceeds to step S1005. Thus, with the present embodiment, for example, the processing in steps S1003 and S1004 (S706) is performed, whereby an example of the second obtaining unit is realized, and for example the final processing date becomes an example of process execution time.

Upon proceeding to step S1005, the processing execution module 313 determines whether or not there is a step prior to the step determined in step S1001 within the workflow definition determined in step S1001. As a result of this determination, in a case where there is no step prior to the step determined in step S1001 within the workflow definition, the flow proceeds to step S1008 described later. On the other hand, there is a step prior to the step determined in step S1001 within the workflow definition, the flow proceeds to step S1006. Upon proceeding to step S1006, the processing execution module 313 determines the final update dates of all steps prior to the step determined in step S1001. Thus, with the present embodiment, for example, the processing in steps S1006 is performed, whereby an example of the first obtaining unit is realized, and the final update date becomes an example of the process content update time. Next, in step S1007, the processing execution module 313 compares “the final processing date of the data to be subjected to processing” determined in step S1003 or S1004, and the final update date determined in step S1006. Here, in step S1004, for example, the date information obtained in step S706 in FIG. 7 becomes the final processing date. Subsequently, the processing execution module 313 determines whether or not there is a step of which the final update date is later than the final processing date, for example, prior to the step determined in step S1001. As a result of this determination, in a case where there is a step of which the final update date is later than the final processing date, the flow proceeds to step S1010, where the processing execution module 313 cancels execution of the processing to be executed in the step determined in step S1001. Subsequently, the UI processing module 311 displays a message on the operating unit 230 to the effect that the data to be handled with the instructed workflow processing is not matched with the current workflow definition, so the instructed workflow processing cannot be continued, thereby informing the user of this. Subsequently, the processing with the flowchart in FIG. 10 is ended. Thus, with the present embodiment, for example, the processing in steps S1007 and S1010 is performed, whereby an example of the canceling unit is realized.

In a case where there is no step of which the final update date is later than the final processing date, the flow proceeds to step S1008. Upon proceeding to step S1008, the processing execution module 313 determines the processing content defined with “the step similarly determined in step S1001” within the workflow definition determined in step S1001, and executes the processing thereof. Next, in step S1009, the processing execution module 313 sets the processed data subjected to processing in step S1008 to the date information when the processing was executed as the final processing date. For example, in a case where the processed data is electronic data, the final processing date information is set as the attributes of the processed data. When the processing executed in step S1008 is the print processing, the processing to be executed in steps S1008 and S1009 becomes the processing described in FIG. 6. In a case where the final processing date has already been set to the processed data subjected to processing in step S1008, the new obtained final processing date is overwritten to the final processing date thereof, thereby updating the final processing date thereof. Thus, with the present embodiment, for example, the processing in step S1009 is performed, whereby an example of an adding unit is realized.

As described above, with the present embodiment, in a case where the workflow processing is the scan processing, the final processing date embedded in paper is extracted, and further, the processing date when the scan processing was executed is embedded in the data of the original read out in the scan processing as the final processing date. On the other hand, in a case where the workflow processing is the print processing, the final processing date information is embedded in the paper (original) to be output by employing two-dimensional barcode or the like.

### SPECIFIC EXAMPLE 1

Next, the processing of each step from steps S1 through S4 of the workflow shown in FIG. 9 will be described with reference to the flowchart in FIG. 10. In a case where the section member instructs the processing in step S1 in FIG. 9, first, in step S1001, the workflow definition file 910 is searched from the workflow definition file information storage module 321. Subsequently, determination is made that the step to be executed with the workflow definition file 910 is step S1 (step No.=“1”).

Next, in step S1002, determination is made that the processing in step S1 of the workflow definition file 910 is the print processing, and the flow proceeds to step S1003. Subsequently, upon proceeding to step S1003, the data to be printed is searched from the box document information storage module 322, and from the data thereof the final processing date of the data thereof is determined. The data to be printed in step S1 is the template data of a purchasing application form. Therefore, either the creation date of the template data is set as the final processing date, or no value is set in particular can be expected. Next, in step S1005, determination is made that there is no step prior to step S1 within the workflow definition file 910 (determined as No), and the flow proceeds to step S1008. Subsequently, in steps S1008 and S1009, the data of the purchasing application form within a ledger sheet box is searched from the box document information storage module 322. Here, step S1 is the print processing, so as described in FIG. 6, the data of the processing execution date is converted into data having a form to be embedded in print data, and this is embedded in purchasing application form data. Subsequently, the print processing of the purchasing application form data in which the processing execution date has been embedded is executed. Subsequently, the processing of step S1 is ended. Now, let us say that the processing execution date of step S1 is “05/01/2007 12:00.”

After the processing in step S1 is executed, the user fills application content in the printed purchasing application form. Subsequently, after filling-in of application content is ended, the processing in step S2 is executed. In a case where a section member has instructed the processing in step S2, first in step S1001, determination is made that the step to be executed with the workflow definition file 910 is step S2 (step No.=“2”).

Next, in step S1002, determination is made that the processing in step S2 of the workflow definition file 910 is the scan processing, and the flow proceeds to step S1004. Subsequently, in step S1004, the processing described in FIG. 7 is executed. First, determination is made in step S701 whether or not there is a purchasing application form disposed by the section member on the scanner 240. Subsequently, when detecting that there is a purchasing application form disposed by the section member, the flow proceeds to step S702.

Upon proceeding to step S702, the data of the purchasing application form created by the section member is scanned by the scanner 240. Next, in step S703, the current date is determined, and in step S704 the information of the current date is converted into a data form which can be embedded in the data of the purchasing application form. Next, determination is made in step S705 whether or not the information of the processing execution date is embedded in the data of the purchasing application form. Here, there is the embedded information of the processing execution date in the processing of step S1, in the data of the purchasing application form. Accordingly, the flow proceeds to step S706, the information of the processing execution date thereof is extracted as the information of the final processing date. Next, in step S707, “the information of the current date” converted in step S704 is embedded in the data of the purchasing application form. Subsequently, in step S708, the data of the purchasing application form scanned in step S702, and the information of the processing execution date extracted in step S706 are temporarily saved in the box document information storage module 322 mutually in a correlated manner.

Upon the above-mentioned processing shown in FIG. 7 being ended, the flow proceeds to step S1005. In step S1005, determination is made that there is step S1 prior to step S2 within the workflow definition file 910 (determined as Yes), the flow proceeds to step S1006. Upon proceeding to step S1006, the final update date of step S1 “04/01/2007 12:00” is determined from the workflow definition file 910. Next, determination is made in step S1007 that there is no step of which the final update date is later than the final processing date of step S1 “05/01/2007 12:00”, the flow proceeds to step S1008. Upon proceeding to step S1008, processing for saving the data of the purchasing application form subjected to the scan processing in an application box, and processing for transmitting an e-mail notice to the effect that filing of purchasing has been performed (purchasing approval request) to the address of the section manager, are executed. Next, in step S1009, the information of the processing execution date is set to the data of the purchasing application form saved in the application box as the attribute of the data of the purchasing application form, and the processing in step S2 is ended. Now, let us say that the processing execution date of step S2 is “05/08/2007 10:00”.

Upon the processing in step S2 being executed, and the section manager who has received a notice by e-mail recognizing that application of purchasing has been performed, the processing in step S3 is executed to confirm the data of the purchasing application form. Upon execution of the processing in step S3 being instructed from the section manager, first determination is made in step S1001 that the step to be executed of the workflow definition file 910 is step S3 (step No.=“3”).

Next, determination is made in step S1002 that the processing in step S3 of the workflow definition file 910 is not the scan processing, and the flow proceeds to step S1003. Subsequently, upon proceeding to step S1003, the data of the purchasing application form within the application box saved in the box document information storage module 322, and the final processing date information “05/08/2007 10:00” which is the attribute of the data of the purchasing application form, are determined. Next, determination is made in step S1005 that there are steps S1 and S2 prior to step S3 (determined as Yes), the flow proceeds to step S1006.

Upon proceeding to step S1006, the final update date of steps S1 and S2 “04/01/2007 12:00” is determined from the workflow definition file 910. Next, determination is made in step S1007 that there is no step of which the final update date is later than the final processing date of step S2 “05/08/2007 10:00”, the flow proceeds to step S1008. Upon proceeding to step S1008, the data of the purchasing application form within the application box is searched from the box document information storage module 322. Here, step S3 is the print processing, so the print processing is executed. As described in FIG. 6, the data of the processing execution date is converted into data having a form which can be embedded in print data, and is then embedded in the data of the purchasing application form. Subsequently, the print processing of the data of the purchasing application form in which the processing execution date has been embedded is executed. Now, let us say that the processing execution date of step S3 is “05/08/2007 14:00”. Note that the data of the purchasing application form within the application box saved in step S2 may be deleted after printing is completed, or may be deleted automatically after a certain period of time. Alternatively, an arrangement may be made wherein the data of the purchasing application form within the application box saved in step S2 is not deleted, information indicating that the processing in step S3 has been executed is added to the data of the purchasing application form, and the history of processed data is saved.

The processing in step S4 is executed for the section manager checking the purchasing application form filed in the processing in step S3, adding the section manager's signature to the purchasing application form, and transferring the document of the purchasing application form to a purchasing section. Upon execution of the processing in step S4 being instructed by the section manager, first in step S1001 determination is made that the step executed of the workflow definition file 910 is step S4 (step No.=“4”). Next, determination is made in step S1002 that the processing in step S2 of the workflow definition file 910 is the scan processing, and the flow proceeds to step S1004. Subsequently, in step S1004, the processing described in FIG. 7 is executed. First, determination is made in step S701 whether or not there is a “purchasing application form with an approval signature” disposed on the scanner 240 by the section manger. Subsequently, upon detecting that there is a purchasing application form disposed by the section manager, the flow proceeds to step S702.

Upon proceeding to step S702, the data of the purchasing application form created by the section manager is scanned by the scanner 240. Next, in step S703, the current date is determined, and in step S704 the information of the current date is converted into a data form which can be embedded in the data of the purchasing application form. Next, determination is made in step S705 that there is the information of the processing execution date (“05/08/2007 14:00”) which has been embedded in the data of the purchasing application form in the above-mentioned processing in step S3, and the flow proceeds to step S706. Upon proceeding to step S706, the information of the processing execution date thereof is extracted as the information of the final processing date. Next, in step S707, “the information of the current date” converted in step S704 is embedded in the data of the purchasing application form. Subsequently, in step S708, the data of the purchasing application form scanned in step S702, and the information of the processing execution date extracted in step S706 are temporarily saved in the box document information storage module 322 mutually in a correlated manner.

Upon the above-mentioned processing shown in FIG. 7 being ended, the flow proceeds to step S1005. In step S1005, determination is made that there are steps S1 through S3 prior to step S4 within the workflow definition file 910 (determined as Yes), and the flow proceeds to step S1006. Upon proceeding to step S1006, the final update date of steps S1 through S3 “04/01/2007 12:00” is determined from the workflow definition file 910. Next, determination is made in step S1007 that the final processing date extracted in step S706 “05/08/2007 14:00” is later than the final update date of steps S1 through S3 “04/01/2007 12:00”, and the flow proceeds to step S1008. Upon proceeding to step S1008, the following processing is performed. Specifically, processing for saving the data of the purchasing application form subjected to the scan processing in an application box by adding approval date to the file name thereof, and processing for informing the address of a general affairs section by e-mail that the purchasing application form has been approved, and purchasing processing thereof is requested, are executed. Next, in step S1009, the information of the processing execution date is set to the data of the purchasing application form saved in the application box as the attribute of the data of the purchasing application form, and the processing of the workflow is ended.

### SPECIFIC EXAMPLE 2

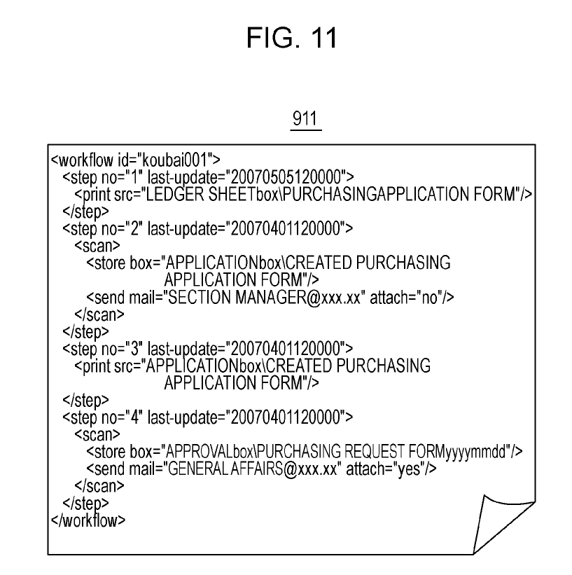

Next, description will be made regarding processing in a case where the template file of the purchasing application form employed for the processing in step S1 has been modified, with reference to the flowchart in FIG. 10. Now, let us say that the template of the purchasing application form has been modified to “05/05/2007 12:00”. FIG. 11 is a diagram illustrating an example of a workflow definition file 911 after the template of the purchasing application form has been modified. In step S1, let us say that the print processing of the data of the purchasing application form of the specific example 1 has been performed. Specifically, in step S1, the template of the purchasing application form before modification is employed, and the data of the processing execution date exemplified in the specific example 1 “05/01/2007 12:00” is embedded in the data of the printed purchasing application form as the data of the final processing date. Now, let us say that a section member has instructed execution of the processing in step S2 at “05/08/2007 10:00”. In response to this, first determination is made in step S1001 that the step to be executed of the workflow definition file 911 is step S2 (step No.=“2”).

Next, determination is made in step S1002 that the processing in step S2 of the workflow definition file 911 is the scan processing, and the flow proceeds to step S1004. Subsequently, in step S1004 the processing described in FIG. 7 is executed. First, determination is made in step S701 whether or not there is a purchasing application form disposed on the scanner 240 by a section member. Subsequently, upon detecting that there is a purchasing application form disposed by the section member, the flow proceeds to step S702. Upon proceeding to step S702, the data of the purchasing application form created by the section member is scanned by the scanner 240. Next, in step S703, the current date is determined, and in step S704 the information of the current date is converted into a data form which can be embedded in the data of the purchasing application form. Next, determination is made in step S705 whether or not the information of the processing execution date is embedded in the data of the purchasing application form. Here, the information of the processing execution date embedded in the processing in step S1 is included in the data of the purchasing application form. Accordingly, the flow proceeds to step S706, where the information of the processing execution date thereof is extracted as the information of the final processing date. Next, in step S707, “the information of the current date” converted in step S704 is embedded in the data of the purchasing application form. Subsequently, in step S708, the data of the purchasing application form scanned in step S702, and the information of the processing execution date extracted in step S706 are temporarily saved in the box document information storage module 322 mutually in a correlated manner.

Upon the above-mentioned processing shown in FIG. 7 being ended, the flow proceeds to step S1005. Determination is made in step S1005 that there is step S1 prior to step S2 within the workflow definition file 911 (determined as Yes), and the flow proceeds to step S1006. Upon proceeding to step S1006, the final update date of step S1 “05/05/2007 12:00” is determined from the workflow definition file 911. Next, determination is made in step S1007 that there is a step of which the final update date is later than the final processing date of step S1 “05/01/2007 12:00”, and the flow proceeds to step S1010. Upon proceeding to step S1010, the processing is cannot be continued any further, so a notice (image) to the effect that the processing is cancelled, and that the template of the purchasing application form has been modified, is displayed on the operating unit 230 (informed to the section member). Subsequently, the processing is canceled, following which the data of the purchasing application form scanned in step S1004 is deleted, and the processing is ended. As described above, with the present embodiment, in a case where the template of the purchasing application form has been modified, and the purchasing application form has to be recreated, the processing can be canceled appropriately so as not to continue the processing.

### SPECIFIC EXAMPLE 3

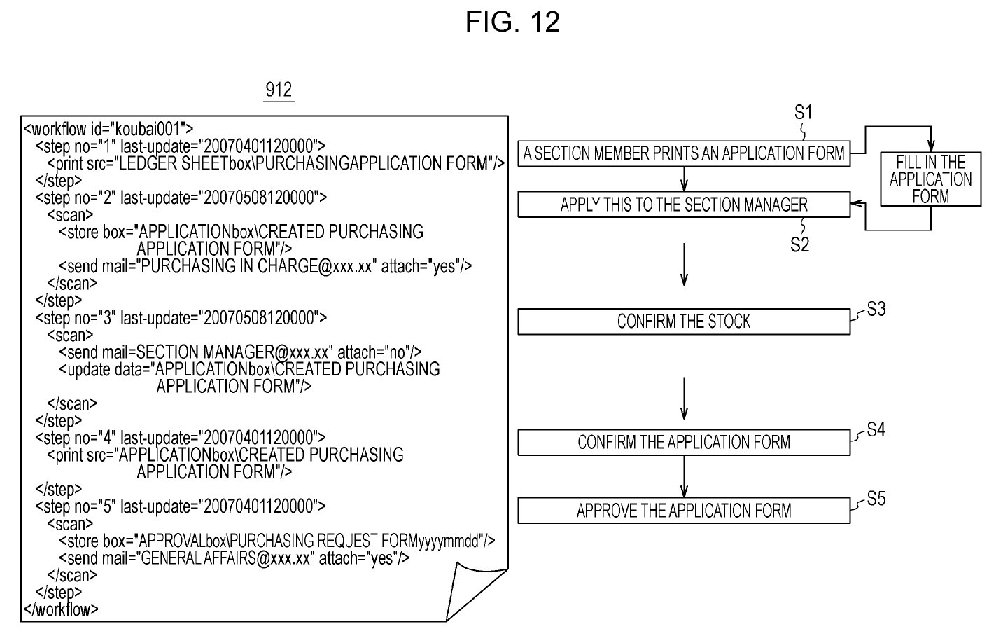

Next, processing in a case where the processing in steps S2 and S3 is modified or added will be described with reference to the flowchart in FIG. 10. Now, let us say that the following modification has been performed to reduce redundant processing by confirming stock before receiving the section manager's approval. Specifically, after filing of the purchasing application form to the section manager is performed in step S2, before confirmation of the purchasing application form by the section manager is performed, a step is newly added wherein confirmation of stock is informed to a person in charge of purchasing. In this newly added step, the person in charge of purchasing confirms stock, and after confirming stock, informs the section manager of an e-mail notice for requesting approval of the purchasing application form. The above-mentioned steps S3 and S4 are modified to steps S4 and S5 according to the newly added step, respectively. Now, let us say that such a modification of the workflow has been performed at “05/08/2007 12:00”. FIG. 12 is a diagram illustrating an example of a workflow definition file 912 after the workflow has been modified. In step S2, such as shown in the specific example 1, let us say that processing for saving the data of the purchasing application form subjected to the scan processing in the application box, and processing for transmitting an e-mail notice to the effect that filing for purchasing has been performed to the section manager's address, have been performed. That is to say, in step S2, an e-mail to the effect that filing for purchasing has been performed has been transmitted to the section manager's address, but confirming of stock has not been requested to the person in charge of purchasing. Accordingly, the final processing date of “05/08/2007 10:00” is embedded in the data of the purchasing application form scanned by the scanner 240. Now, let us say that the section manager has viewed the e-mail transmitted from a section member, and has instructed execution of the processing in step S3 before modification at “05/08/2007 14:00” without noticing that the workflow definition file has been updated, in the same way as with the specific example 1.

The processing in step S2 has been executed, but the section manager who has received the notice by e-mail has recognized that filing for purchasing has been performed without noticing that the workflow definition file has been modified. In such a case, upon the section manager performing an instruction to confirm the data of the purchasing application form, determination is made in step S1001 that the step to be executed of the workflow definition file 912 is step S4 (step No.=“4”). Next, determination is made in step S1002 that the processing in step S4 is not the scan processing, and the flow proceeds to step S1003. Subsequently, upon proceeding to step S1003, the data of the purchasing application form within the application box saved in the box document information storage module 322, and the final processing date information “05/08/2007 10:00” which is the attribute of the data of the purchasing application form, are determined. Next, determination is made in step S1005 that there are steps S1 through S3 prior to step S4 (determined as Yes), and the flow proceeds to step S1006.

Upon proceeding to step S1006, the final update date “05/08/2007 12:00” of steps S2 and S3 is determined from the workflow definition file 912. The final update date of steps S2 and S3 is “05/08/2007 12:00”. Accordingly, determination is made in step S1007 that there are steps S2 and S3 of which the final update date is later than the final processing date of step S2 “05/08/2007 10:00”. Subsequently, the flow proceeds to step S1010, where the processing is canceled. At this time, a notice to the effect that the processing is canceled, and that the workflow definition file has been updated, is given to the section manager through the operating unit 230. As described above, with the present embodiment, in a case where a job which has been processed to the middle has not been subjected to necessary processing by the workflow being modified or added, the processing can be canceled appropriately so as not to continue the processing.

### SPECIFIC EXAMPLE 4

The specific example 3 has shown the case where the time when the processing in step S2 was executed is “05/08/2007 10:00”, but let us say that the time when the processing in step S2 was executed is “05/08/2007 13:00”. The points other than this are the same as those in the specific example 3. That is to say, modification of the workflow has been performed at “05/08/2007 12:00”, and accordingly, with the present example, when the processing in step S2 was executed, the workflow definition file had already been updated to a new workflow definition file 912. In such a case, a step has been added in the same way as with the specific example 3, whereby the workflow definition file has been updated, but even if the section manager performs confirmation of the purchasing application form without recognizing modification of the workflow definition file in the same way as with the specific example 3, the processing is continued without being canceled. This is because determination is made in step S1006 that the final processing date of step S2 “05/08/2007 13:00” is later than the final update date of steps S2 and S3 “05/08/2007 12:00”.

Upon the processing in step S2 being instructed by a section member, determination is made that the step to be executed of the workflow definition file 912 is step S2 (step No.=“2”). That is to say, the processing in new step S2 is executed, and an e-mail indicating that confirming of stock is requested is transmitted to the address of the person in charge of purchasing. At this time, in order that the person in charge of purchasing has not to access the data of the purchasing application form within the box document information storage module 322, it is desirable to transmit the same data as the data of the purchasing application form thereof by being appended to the e-mail thereof. Upon receiving the e-mail thereof, the person in charge of purchasing prints the data of the purchasing application form appended to the e-mail thereof to confirm the content thereof, and performs confirming of stock. Now, description will be made here assuming that the person in charge of purchasing has confirmed stock.

Upon the processing in step S3 being instructed by the person in charge of purchasing, determination is made in step S1001 that the step to be executed of the workflow definition file 912 is step S3 (step No.=“3”). Next, determination is made in step S1002 that the processing in step S3 of the workflow definition file 912 is the scan processing. Subsequently, the flow proceeds to step S1004, where the scan processing shown in FIG. 7 is executed. At this time, the information of the processing execution date to be extracted in step S706 is the information of the processing execution date which has been embedded in the data of the purchasing application form at the scan processing in step S2. That is to say, the information of the processing execution date to be extracted in step S706 is the processing execution date embedded in the data of the purchasing application form appended to the e-mail. Accordingly, the date to be extracted is “05/08/2007 13:00”.

Upon the scan processing being executed in step S1004, determination is made in step S1005 that there are steps S1 and S2 prior to step S3 within the workflow definition file 912 (determined as Yes), and the flow proceeds to step S1006. Upon proceeding to step S1006, the final update date of step S1 “04/01/2007 12:00” and the final processing date of step S2 “05/08/2007 12:00” are determined from the workflow definition file 912. Subsequently, determination is made in step S1007 that there is no step of which the final update date is later than the final update date of step S2 “05/08/2007 13:00”, the flow proceeds to step S1008. Upon proceeding to step S1008, processing for transmitting an e-mail notice indicating that filing for purchasing has been performed (purchasing approval request) to the address of the section manager, and processing for updating the final processing date which is the attribute of the data of the purchasing application form within the application box, are performed. For example, let us say that the processing execution date (final processing date) of step S3 is “05/09/2007 12:00”.

In a case where the processing in step S4 has been executed for the section manager who has received a notice by e-mail confirming the data of the purchasing application form, the final processing date of the data of the purchasing application form to be executed in step S4 is “05/09/2007 12:00”. On the other hand, the final update dates of steps S1 through S3 prior to step S4 are “04/01/2007 12:00”, “05/08/2007 12:00”, and “05/08/2007 12:00”, respectively. Accordingly, the final processing date of the data of the purchasing application form “05/09/2007 12:00” is later than the final update dates of steps S1 through S3. Accordingly, determination is made as Yes in step S1007, the normal processing is continued (steps S1008 and S1009). As described above, with the present embodiment, a job made up of steps causing no problem even if the processing is continued without canceling all of the jobs even when a workflow definition file has been updated, can be processed appropriately.

As described above, with the present embodiment, the final update date information relating to the updated date is given to each of the steps of the workflow definition files 910 through 912. Also, when executing each of the steps of the workflow definition files 910 through 912, the processing execution date information relating to the executed date thereof is given to the data processed in the step thereof. Subsequently, when executing each of the steps of the workflow definition files 910 through 912, from the processing execution date information appended to the data processed in the step thereof, the final processing date of the data thereof is determined. Next, in a case where the update date determined from the final update date information in a step (job) prior to the step (job) to be executed is later than the final processing date of the data to be processed in the step to be executed, the processing in the step to be executed is canceled. On the other hand, in a case where the update date determined from the final update date information in a step prior to the step to be executed is not later than the final processing date of the data to be processed in the step to be executed, the processing in the step to be executed is continued. Accordingly, in a case where a workflow definition has been modified or added, canceling or continuation of the job being processed can be determined appropriately without employing a management server for managing jobs to be executed with a workflow. Thus, a workflow can be executed appropriately without employing a server for managing jobs to be executed with a workflow.

Next, a second embodiment of the present invention will now be described. With the above-mentioned first embodiment, in a case where the update date of a step prior to the step to be executed is later than the final processing date of the data to be processed in the step to be executed, the processing in the step to be executed is canceled without conditions. On the other hand, with the present embodiment, in such a case, information indicating whether to cancel or continue the processing in the step to be executed is added to a workflow definition file, whereby the processing can be continued depending on conditions. Thus, the present embodiment and the first embodiment differs primarily regarding the content of a workflow definition file, and the processing in a case where the update date in a step prior to the step to be executed is later than the final processing date of the data to be processed in the step to be executed. Accordingly, with the description in the present embodiment, the same portions as those in the first embodiment are denoted with the same reference numerals as those in FIGS. 1 through 12, and accordingly, detailed description thereof will be omitted.

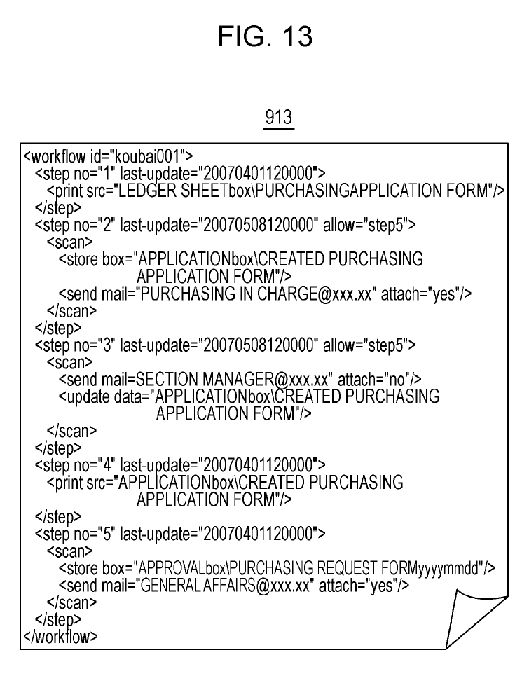

FIG. 13 is a diagram illustrating an example of a workflow definition file 913. The workflow definition file 913 shown in FIG. 13 is the same workflow as the workflow definition file 912 shown in FIG. 12. With the workflow definition file 913, “allow=“step 5”” is defined as to steps S2 and S3. Therefore, in a case where the step (job) to be executed is step S5 and thereafter, even if the final update dates of steps S2 and S3 are later than the final processing date of the step (job) to be executed, the processing in the step (job) thereof is not canceled but permitted.

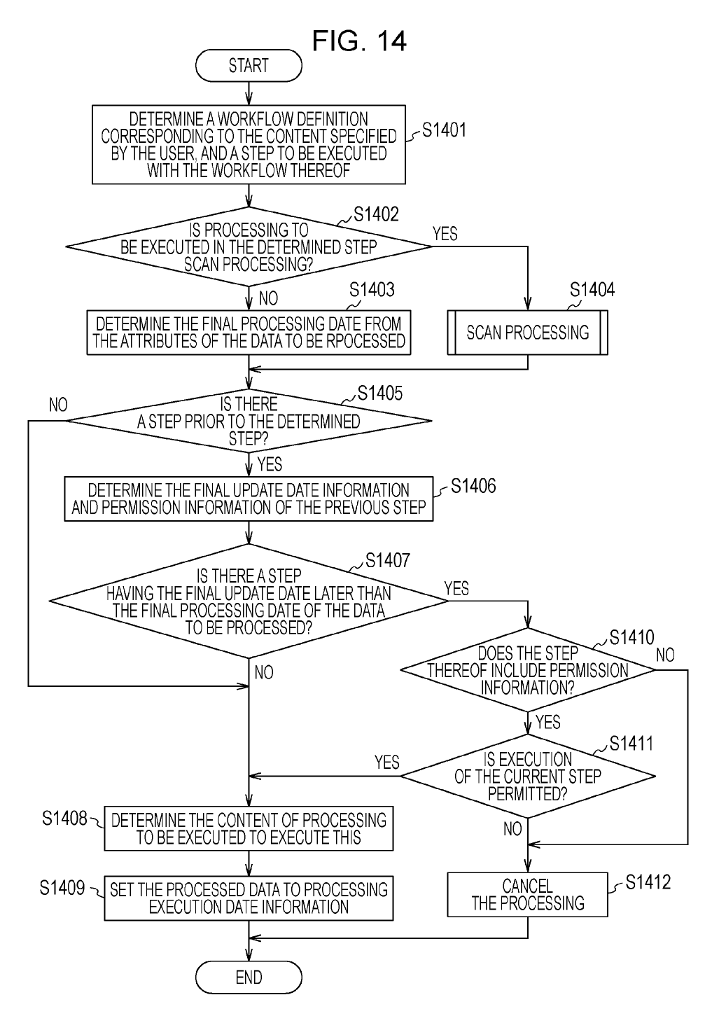

Let us say that up to the confirmation processing of the purchasing application form by the section manager had been executed until “05/08/2007 10:00”. Subsequently, let us say that the workflow definition file has been updated from the workflow definition file 910 shown in FIG. 9 to the workflow definition file 913 shown in FIG. 13 at “05/08/2007 12:00”. In this case, with the purchasing application form printed for confirming the purchasing application form, “05/08/2007 10:00” has been embedded as the final processing date at the time of printing. Subsequently, in order to approve the purchasing application form, the section manager selected a purchasing request approval button of the image forming apparatus 110 to instruct execution of the processing in step S5 at “05/08/2007 13:00”. The processing in this case will be described with reference to the flowcharts in FIGS. 14 and 7.

Upon execution of approval of the purchasing application form being instructed from the section manager, determination is made in step S1401 that the step to be executed of the workflow definition file 913 is step S5 (step No.=“5”). Next, determination is made in step S1402 that the processing in step S5 of the workflow definition file 913 is the scan processing, and the flow proceeds to step S1404. Subsequently, in step S1404 the processing described in FIG. 7 is executed. First, determination is made in step S701 whether or not there is a purchasing application form with an approval signature disposed on the scanner 240 by the section manager. Subsequently, upon detecting that there is a purchasing application form disposed by the section manager, the flow proceeds to step S702.

Upon proceeding to step S702, the data of the purchasing application form created by the section manager is scanned by the scanner 240. Next, in step S703, the current date is determined, and in step S704 the information of the current date is converted into a data form which can be embedded in the data of the purchasing application form. Next, determination is made in step S705 that there is the information of the processing execution date (“05/08/2007 10:00”) which has been embedded in the purchasing application form in the print processing in step S3, and the flow proceeds to step S706. Upon proceeding to step S706, the information of the processing execution date thereof is extracted as the information of the final processing date.

Next, in step S707, “the information of the current date” converted in step S704 “05/08/2007 13:00” is embedded in the data of the purchasing application form. Subsequently, in step S708, the data of the purchasing application form scanned in step S702, and the information of the processing execution date extracted in step S706 are temporarily saved in the box document information storage module 322 mutually in a correlated manner. As described above, with the present embodiment, for example, the processing in step S1404 (S706) is performed, whereby an example of the second obtaining unit is realized, and for example, the final processing date is an example of the process execution time.

Upon the above-mentioned processing shown in FIG. 7 being ended, the flow proceeds to step S1405. Upon proceeding to step S1405, determination is made that there are steps S1 through S3 prior to step S5 within the workflow definition file 913 (determined as Yes), and the flow proceeds to step S1406. In step S1406, the information of the final update dates of steps S1 through S4, and permission information indicating whether to permit a step (job) of which the final processing date is earlier than the final update date, are determined. As described above, with the present embodiment, for example, the processing in step S1406 is performed, whereby an example of the first obtaining unit is realized, the final update date becomes an example of the process content update time, and further, the permission information becomes an example of the processing propriety information. Next, determination is made in step S1407 that the final processing date extracted in step S706 “05/08/2007 10:00” is earlier than the final update dates of steps S2 and S3 “05/08/2007 12:00”, so the flow proceeds to step S1410.

Upon proceeding to step S1410, determination is made with reference to the workflow definition file 913 whether or not the steps S2 and S3 of which the final update dates are later than the final processing date extracted in step S706 include permission information. The steps S2 and S3 of the workflow definition file 913 include permission information of “allow=“step 5””, so the flow proceeds to step S1411. Upon proceeding to step S1411, determination is made whether or not execution of step S5 which is the step to be executed is permitted with the permission information. According to the permission information of “allow=“step 5””, execution of step S5 is permitted. Accordingly, the flow proceeds to step S1408. Note that in a case where determination is made as No in step S1407 as well, the flow proceeds to step S1408. Also, steps S1410 and S1411 are executed by the processing execution module 313.

Upon proceeding to step S1408, the next processing is performed. Specifically, processing for saving the data of the purchasing application form subjected to the scan processing in an application box by adding approval date to the file name thereof, and processing for informing the address of a general affairs section by e-mail that the purchasing application form has been approved, and purchasing processing thereof is requested, are executed. Next, in step S1409, the information of the processing execution date is added to the data of the purchasing application form saved in the application box as the attribute of the data of the purchasing application form, and the processing is ended. As described above, with the present embodiment, for example, the processing in step S1409 is performed, whereby an example of the adding unit is realized.

Let us say that up to the filing processing of the purchasing application form by a section member had been executed until “05/08/2007 10:00.” Subsequently, let us say that the workflow definition file has been updated from the workflow definition file 910 shown in FIG. 9 to the workflow definition file 913 shown in FIG. 13 at “05/08/2007 12:00”. In this case, the final processing date “05/08/2007 10:00” is set to the data of the purchasing application form within the application box as the attribute. Subsequently, let us say that in order to confirm the purchasing application form, the section manager has selected a purchasing request check button of the image forming apparatus 110 at “2007/05/08 13:00” to instruct execution of the processing in step S3 before modification. The processing in this case will be described with reference to the flowchart in FIG. 14.

Upon execution of confirmation of the purchasing application form being instructed from the section manager, determination is made in step S1401 that the step to be executed of the workflow definition file 913 is step S4 (step No.=“4”). Next, determination is made in step S1402 that the processing in step S4 of the workflow definition file 913 is not the scan processing, and the flow proceeds to step S1403. Upon proceeding to step S1403, the data of the purchasing application form within the application box saved in the box document information storage module 322, and the final processing date information which is the attribute of the data of the purchasing application form thereof “05/08/2007 10:00”, are determined. As described above, with the present embodiment, for example, the processing in step S1403 is performed, whereby an example of the second obtaining unit is realized. Next, determination is made in step S1405 that there are steps S1 through S3 prior to step S4 (determined as Yes), and the flow proceeds to step S1406.

Upon proceeding to step S1406, the information of the final update dates of steps S1 through S3, and permission information indicating whether to permit a step (job) of which the final processing date is earlier than the final update date, are determined. Subsequently, determination is made in step S1407 that the final processing date “05/08/2007 10:00” is earlier than the final update dates of steps S2 and S3 “05/08/2007 12:00”, so the flow proceeds to step S1410.

Upon proceeding to step S1410, determination is made that steps S2 and S3 of which the final update dates are later than the final processing date include permission information, so the flow proceeds to step S1411. Upon proceeding to step S1411, determination is made whether or not execution of step S4 which is the step to be executed is permitted with the permission information. According to the permission information of “allow=“step 5””, execution of step S4 is permitted. Accordingly, the flow proceeds to step S1412, where the processing is canceled. As described above, with the present embodiment, for example, the processing in steps S1407, and S1410 through S1412 is performed, whereby an example of the canceling unit is realized. Note that the processing in step S1403 is the same as the processing in step S1103 shown in FIG. 10, so detailed description thereof will be omitted with the present embodiment.

As described above, with the present embodiment, the permission information indicating whether to permit a step (job) of which the final processing date is earlier than the final update date of the step (job) to be executed, is added to at least one step of the workflow definition file 913. Accordingly, in addition to the advantage described in the first embodiment, an advantage can be obtained wherein determination can be made without employing a management server whether or not a job which does not have to be canceled even if the workflow definition thereof were modified or added is being processed. For example, if the current stage is a stage where the approval has already been made, stock confirmation may be omitted, but if the current stage is a stage where confirmation of the application form is performed before work for approval is performed, it is better to perform stock confirmation. Even in such a case, determination can be made appropriately whether to execute the processing. Note that the present embodiment has exemplified the case where the permission information is information indicating whether to permit execution of each process according to the progress of the workflow to be executed, but the permission information is not restricted to such information. For example, the permission information may be information indicating only permission or denial of execution.

Next, a third embodiment of the present invention will be described. With the present embodiment, when canceling the processing, a canceling method is changed according to the content of the processing. Thus, a part of the method for canceling the processing principally differs between the present embodiment and the above-mentioned first and second embodiments. Accordingly, with the description in the present embodiment, the same portions as those in the first and second embodiments are denoted with the same reference numerals as those in FIGS. 1 through 14, and accordingly, detailed description thereof will be omitted.

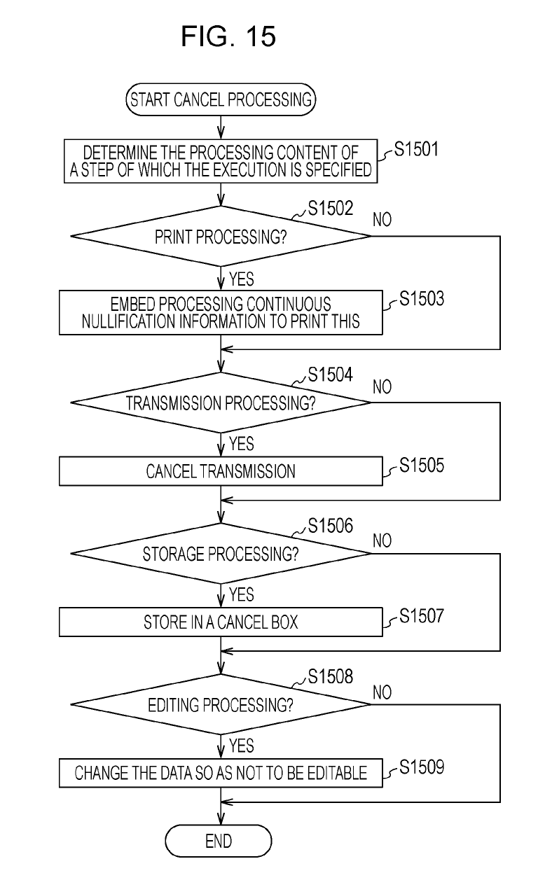

FIG. 15 is a flowchart describing an example of the processing of the workflow processing software at the time of canceling the processing. The flowchart in FIG. 15 is executed, for example, instead of step S1010 in FIG. 10, and step S1412 in FIG. 14. First, in step S1501, the processing execution module 313 determines the processing content of the step (job) of which the execution has been instructed by the user. Next, in step S1502, the processing execution module 313 determines whether or not the processing content determined in step S1501 is the print processing. As a result of this determination, in a case where the processing content includes no print processing, step S1503 is skipped, and the flow proceeds to later-described step S1504.

In a case where the processing content includes the print processing, the flow proceeds to step S1503. Upon proceeding to step S1503, the processing execution module 313 embeds processing-continuation-nullification information in print data. The processing-continuation-nullification information is not the final processing date information to be embedded originally, but a grayed-out block to indicate prohibition of the scan processing, information by two-dimensional barcode, the stamp information of a message to the effect that the processing has been canceled, or the like. Accordingly, even in a case where the user erroneously attempts to perform the next processing by employing paper such as a printed application form or the like, the image forming apparatus 110 can determine that the processing has been canceled, appropriately. Subsequently, the control module 312 outputs the print data in which the processing-continuation-nullification information has been embedded to the printer image processing unit 215 through the image bus interface 205. The printer image processing unit 215 collaborates with the image rotating unit 216 or the like as necessary to subject the print data thereof to processing, and outputs the print data subjected to the processing to the printer 250 through the device interface 213. Subsequently, the printer 250 performs printing based on the input print data, and the flow proceeds to step S1504.

Upon proceeding to step S1504, the processing execution module 313 determines whether or not the processing content determined in step S1501 includes transmission processing. As a result of this determination, in a case where the processing content includes no transmission processing, step S1505 is skipped, and the flow proceeds to later-described step S1506. In a case where the processing content includes the transmission processing, the flow proceeds to step S1505. Upon proceeding to step S1505, the processing execution module 313 cancels the transmission processing thereof. Thus, the next processing is not informed to the user. Accordingly, the processing can be stopped at this point. Subsequently, the flow proceeds to step S1506.

Upon proceeding to step S1506, the processing execution module 313 determines whether or not the processing content determined in step S1501 includes saving processing to the box. As a result of this determination, in a case where the processing content does not include the saving processing to the box, step S1507 is skipped, and the flow proceeds to later-described step S1508. In a case where the processing content includes the saving processing to the box, the flow proceeds to step S1507. Upon proceeding to step S1507, the data input/output module 315 saves the data to be executed in a box for canceling data. Thus, the data which should have been canceled can be prevented from being subjected to processing erroneously later. Further, the box for canceling is displayed on the touch panel portion 420 or the like to allow the user to view this, whereby the user can readily know which job has been canceled. Note that the box for canceling data is stored in, for example, the box document information storage module 322. Subsequently, the flow proceeds to step S1508.

Upon proceeding to step S1508, the processing execution module 313 determines whether or not the processing content determined in step S1501 includes editing processing such as combining of documents, page deletion, and so forth. As a result of this determination, in a case where the processing content includes no editing processing, step S1509 is skipped, and the processing in accordance with the flowchart in FIG. 15 is ended. In a case where the processing content includes the editing processing, the flow proceeds to step S1509. Upon proceeding to step S1509, the processing execution module 313 locks the data to be executed so as not to be edited. Thus, the data can be prevented from being edited at another processing erroneously, and further, the data can also be assured that the data has not been edited. As described above, with the present embodiment, for example, the flowchart in FIG. 15 is executed, whereby an example of the execution unit is realized.

As described above, with the present embodiment, when canceling processing, appropriate canceling processing is performed according to the processing which should be performed originally without canceling the processing thereof. Accordingly, in addition to the advantages described in the first and second embodiments, an advantage can be obtained wherein user operation mistakes and redundant processing can be prevented.

Next, a fourth embodiment of the present invention will be described. The above-mentioned first embodiment has exemplified the case where no management server is provided within the system. Conversely, with the present embodiment, a management server is provided within the system, and in a case where the management server is temporarily in an inoperative state, a workflow is executed without employing the management server, and after the management server is restored, the log (record) thereof is informed to the management server. Thus, the present embodiment differs from the above-mentioned first through third embodiments principally in that the management server is provided within the system, and the processing of the image forming apparatus 110 is changed by the management server being provided. Accordingly, with the description in the present embodiment, the same portions as those in the first through third embodiments are denoted with the same reference numerals as those in FIGS. 1 through 15, and accordingly, detailed description thereof will be omitted.

As described in the above-mentioned first through third embodiments, a workflow can be appropriately processed even in a state in which no management server is provided in the system. Conversely, with the present embodiment, description will be made regarding a case where the management server, which is originally provided in the system and is able to manage workflows, fails to perform management of workflows temporarily. Here, description will be made regarding processing in a case where the management server is down temporarily, and accordingly, management of workflows is unavailable temporarily, as an example.

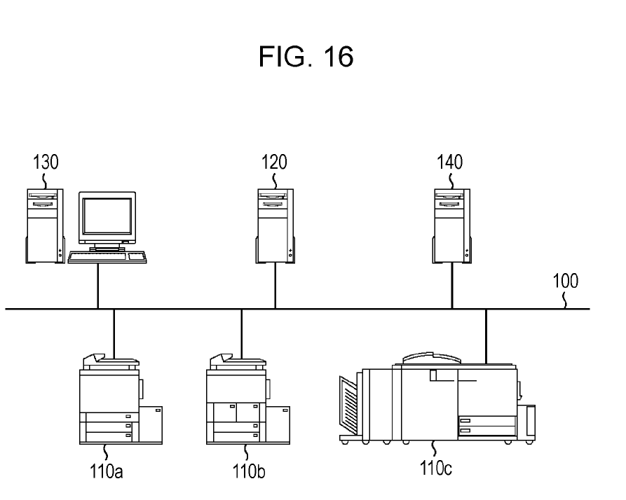

FIG. 16 is a diagram illustrating an example of the entire configuration of a workflow processing system. The workflow processing system shown in FIG. 16 is equivalent to the workflow processing system shown in FIG. 1 to which a workflow management server 140 has been added. The workflow management server 140 manages the information of all workflows processed in the system, and manages to which step of which workflow has been processed. When executing the processing of a workflow, each image forming apparatus 110 inquires of the workflow management server 140 regarding the information of a step (job) to be executed, thereby determining whether to continue or cancel the processing.

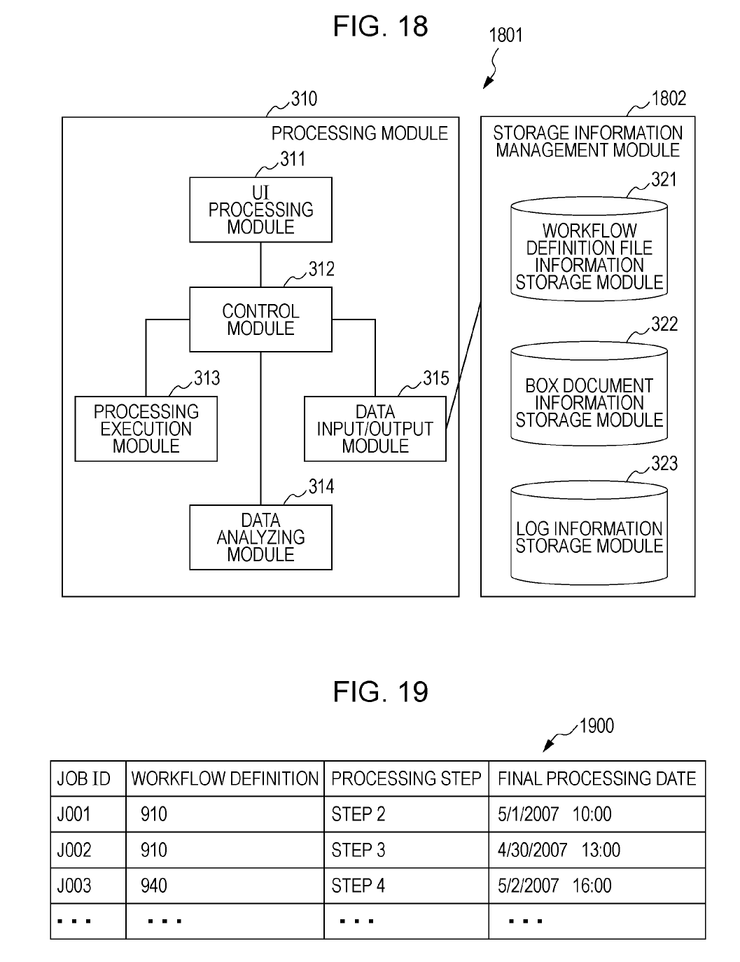

FIG. 18 is a block diagram illustrating an example of the functional configuration of workflow processing software to be executed at the image forming apparatus 110. The workflow processing software 1801 shown in FIG. 18 is equivalent to the workflow processing software 300 shown in FIG. 3 except that a log information storage module 323 is added to a storage information management module 1802. The log information storage module 323 stores the content (record) of the step (job) of the workflow executed at the time of the workflow management server 140 being down, in a recording medium.

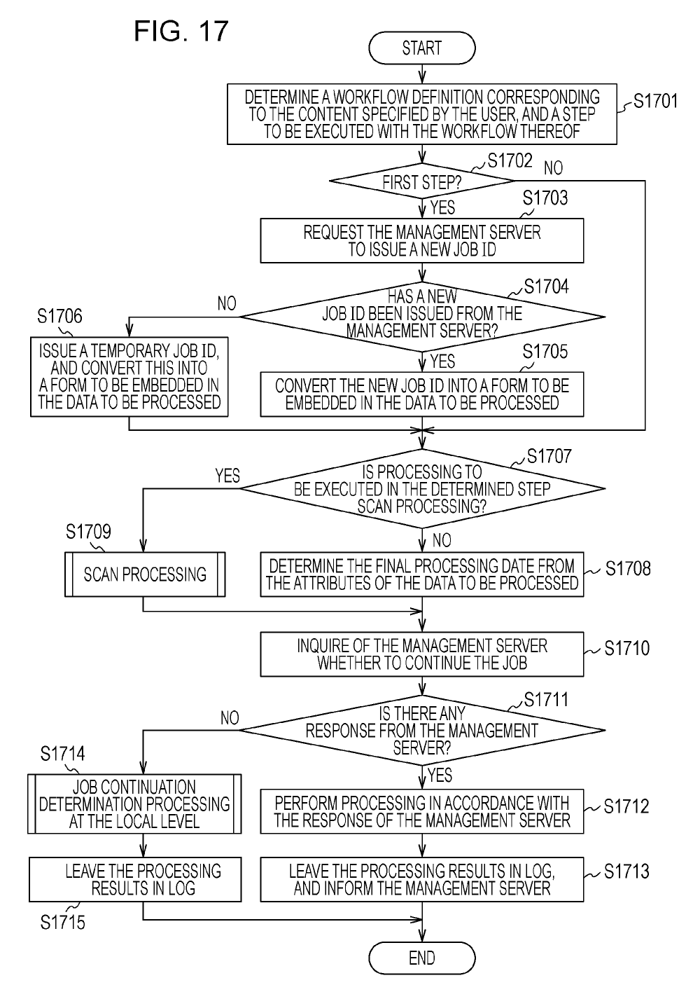

FIG. 17 is a flowchart describing an example of the processing of the workflow processing software 1801 within the image forming apparatus 110. In step S1701, the data input/output module 315 searches the content of the user's instruction received at the UI processing module 311 from the workflow definition file information storage module 321. Subsequently, the data input/output module 315 determines, based on the search results, the workflow definition corresponding to the workflow processing instructed by the user, and the information of a step to be executed at the workflow thereof.

In step S1702, the processing execution module 313 determines whether or not the step determined in step S1701 is the first step within a series of processing of the workflow definition. As a result of this determination, where the step determined in step S1701 is not the first step, the flow proceeds to step S1707. Where the step determined in step S1701 is the first step, the flow proceeds to step S1703. Upon proceeding to step S1703, in order to start a new job, the control module 312 requests issuance of a new job ID from the workflow management server 140.

In step S1704, the control module 312 determines whether the new job ID serving as the response to the request performed in step S1703 has been received from the workflow management server 140, within a predetermined period. As a result of this determination, the flow proceeds to step S1705. Upon proceeding to step S1705, the processing execution module 313 converts the data of the new job ID into data having a form, which can be embedded in the data to be processed. Subsequently, the flow proceeds to step S1707. In a case where the workflow management server 140 is down in a state of preventing the new job ID from returning to the image forming apparatus 110, and accordingly, determination made in step S1704 that the new job ID has not been received, the flow proceeds to step S1706. Upon proceeding to step S1706, the processing execution module 313 issues a temporary job ID within the workflow processing software 1801, and converts the temporary job ID into data having a form which can be embedded in the data to be processed. Subsequently, the flow proceeds to step S1707.

Upon proceeding to step S1707, the processing execution module 313 determines whether the processing in the step determined in step S1701 is the scan processing. As a result of this determination, where the processing in the step determined in step S1701 is the scan processing, the flow proceeds to step S1709, where the scan processing described in FIG. 7 is executed, and the flow proceeds to step S1710. In a case where the processing in the step determined in step S1701 is not the scan processing, the flow proceeds to step S1708. Upon proceeding to step S1708, the processing execution module 313 determines from the data to be subjected to processing (e.g., attribute information) the final processing date of the data to be subjected to processing thereof. Subsequently, the flow proceeds to step S1710. The processing in steps S1708 and S1709 (S706) is performed, whereby an example of the second obtaining unit is realized, the final processing date becomes an example of the process execution time.

Upon proceeding to step S1710, the control module 312 employs the final processing date determined in step S1708 or S1709, and job ID to inquire of the workflow management server 140 whether the processing can be executed. The processing in step S1710 is performed, whereby an example of the inquiring unit is realized. In step S1711, the control module 312 determines whether the response as to the inquiry performed in step S1710 has been received from the workflow management server 140, within a predetermined period. As a result of this determination, in the case of receiving the response from the workflow management server 140, the flow proceeds to step S1712. Upon proceeding to step S1712, if the response from the workflow management server 140 indicates continuation, the processing execution module 313 executes the processing defined in the workflow. If the response from the workflow management server 140 indicates canceling, the processing execution module 313 cancels the processing. In step S1713, the data input/output module 315 stores the processing results obtained in step S1712 in the log information storage module 323 shown in FIG. 18 as a log. Subsequently, the control module 312 informs the workflow management server 140 of the log information thereof as processing results. Subsequently, the processing in accordance with the flowchart in FIG. 17 is ended.

In step S1711, where the response from the workflow management server 140 has not been received, the flow proceeds to step S1714. Upon proceeding to step S1714, the processing in steps S1005 through S1010 in FIG. 10 or the processing in steps S1405 through S1412 in FIG. 14 is executed as job continuation determining processing at a local level. The processing in step S1714 (steps S1406, S1407, and S1410 through S1412) is performed, whereby examples of the first obtaining unit and canceling unit are realized, and the final update date is an example of the process content update time. Subsequently, in step S1715, the data input/output module 315 stores the processing results obtained in step S1714 in the log information storage module 323 as log. At this time, the data input/output module 315 leaves that the processing has been performed at a local level without informing the workflow management server 140, in the log information storage module 323 along with the log. The processing in step S1714 is performed, whereby an example of the storage unit is realized, and the log becomes an example of the execution result information.

Where the workflow management server 140 has been down, and accordingly, a temporary job ID has been issued, and the information of logging stored in the log information storage module 323 is restricted to log performed locally without employing the workflow management server 140, the following processing is performed. The image forming apparatus 110 confirms periodically whether or not the response from the workflow management sever 140 has been received, or the like, thereby confirming the activation of the workflow management sever 140. Subsequently, upon detecting the restoration (resumption) of the operation of the workflow management server 140, the image forming apparatus 110 transmits the temporary job ID, and the information of logging performed locally, to the workflow management server 140. The image forming apparatus 110 may selectively transmit to the workflow management server 140 the information of logging obtained since the operation of the workflow management server 140 has been stopped until the restoration thereof. Upon receiving such information, the workflow management server 140 updates a job information table managed by the server 140 to the latest information. The image forming apparatus 110 transmits a temporary job ID, and the information of logging performed locally to the workflow management server 140, whereby an example of the transmission unit is realized.

FIG. 19 is a diagram illustrating an example of the table to store job information managed by the workflow management server 140. With the management table 1900 shown in FIG. 19, information is managed, such that the job corresponding to a job ID is included in which workflow definition, and is advanced to which step, and when the processing of the final step was executed. Further, with workflow management server 140, the workflow definition of each workflow is also managed, and the workflow definitions are always kept in the latest versions. Therefore, upon obtaining the information of a job ID and the final processing date of the workflow processing software 1801 of the image forming apparatus 110, and receiving a request for determining the propriety of continuation of each step (job) of a workflow, the workflow management server 140 can perform the following processing. The workflow management server 140 can determine whether or not the final processing date of the data to be processed is earlier than the final update date of the step to be executed, by employing the latest workflow definition thereof.

In a case where a new job ID is not issued from the workflow management server 140, the image forming apparatus 110 issues a temporary job ID. The image forming apparatus 110 confirms whether the response from the workflow management server 140 has been received. In a case where the response has been received, and in a case where a temporary job ID has been issued, the image forming apparatus 110 employs the temporary job ID thereof to perform the processing of the step to be executed. Subsequently, the image forming apparatus 110 transmits the log of the processing thereof to the workflow management server 140 along with the temporary job ID. In a case where the response has not been received from the workflow management server 140, the image forming apparatus 110 executes the processing of the workflow locally as described in the first through third embodiments, and stores the log of the processing thereof, and that the log thereof has been executed locally. In a case where the response has been received from the workflow management server 140, the image forming apparatus 110 transmits such data to the workflow management server 140. The workflow management server 140 employs the information thus obtained from the image forming apparatus 110 to update the content of the management table 1900 for managing the progress situation of a workflow.

Accordingly, even in a case where the workflow management server 140 for managing workflows is down, or the maintenance thereof is stopped temporarily, the processing of a workflow can be continued appropriately as quickly as possible without interrupting the processing of a workflow. Further, the information managed by the workflow management server 140 may be matched to the execution results of an actual workflow.

### Other Embodiments

Each unit making up the workflow execution device according to the above-mentioned embodiments, and each step of the workflow execution method, can be realized by running a program stored in RAM, ROM, or the like, of a computer. This program and computer-readable recording media recording such program are also encompassed in the present invention.

Also, the present invention may be employed as an embodiment, for example, such as a system, device, method, program, recording medium, or the like, and specifically, may be applied to a system configured of multiple devices, or may be applied to a device configured of one piece of equipment.

Note that the present invention encompasses a case where software programs for realizing the functions of the above-mentioned embodiments (programs corresponding to the flowcharts shown in FIGS. 6, 7, 10, 14, 15, and 17 with the embodiments) are supplied to a system or device directly or remotely. Also, the present invention encompasses a case where the functions of the above-mentioned embodiments are achieved by the computer of a system or device reading out the supplied program code to execute this.

Accordingly, in order to realize the function processing of the present invention by a computer, the program code itself to be installed to the computer also realizes the present invention. That is to say, the present invention also encompasses the computer program itself to realize the function processing of the present invention.

In this case, the program may have any form, such as object code, program executed by an interpreter, script data supplied to an OS, or the like, as long as the program has the functions of a program.

Examples of a recording medium for supplying the program include a floppy (registered trademark) disk, hard disk, optical disc, magneto-optical disk, MO, CD-ROM, CD-R, CD-RW, and so forth. Alternatively, a magnetic tape, nonvolatile memory card, ROM, DVD (DVD-ROM, DVD-R), and so forth may be employed.

Additionally, as for a program supply method, the program may be supplied by employing a browser of a client computer to connect to an homepage of the Internet, and downloading a file of the computer program itself of the present invention, or a file including the compressed program including an automatic install function, from the homepage to a recording medium such as a hard disk or the like.

The program may also be supplied by dividing program code making up the program of the present invention into multiple files, and downloading each file from a different homepage. That is to say, the present invention also encompasses a WWW server device for allowing multiple users to download the program file for realizing the function processing of the present invention at a computer.

Also, the program may also be supplied by encrypting the program of the present invention, storing this in a recording medium such as CD-ROM or the like, distributing this to users, allowing a user satisfying predetermined conditions to download key information for decrypting encryption from a homepage through the Internet, and allowing the user to execute the encrypted program by employing the downloaded key information to install this in a computer.

The functions of the above-mentioned embodiments are realized by the computer executing the supplied and read program. Additionally, the functions of the above-mentioned embodiments may also be realized with processing which is part or all of the actual processing performed by the operating system or the like running on the computer, based on the instructions of the program thereof.

Further, in a case where the program read out from a recording medium is written in memory included in a function expansion board inserted in the computer or function expansion unit connected to the computer, the functions of the above-mentioned embodiments may also be realized with processing which is a part or all of the actual processing performed by a CPU or the like included in the function expansion board or function expansion unit based on the instructions of the program thereof.

Note that the above-mentioned respective embodiments simply show specific examples at the time of implementing the present invention, and the technical scope of the present invention is not to be interpreted by those in a limited manner. That is to say, the present invention can be implemented in various forms without departing from the technical idea or principal features thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2008-106071 filed Apr. 15, 2008, which is hereby incorporated by reference herein in its entirety.

What is claimed is:

1. A workflow execution device configured to execute, based on a workflow definition file in which the contents of processes within a workflow, and process content update time which is time when the content of at least one of the processes was updated are set, the processes of the workflow, comprising:
an adding unit configured to add, upon processing in accordance with the content of the process of the workflow being executed, process execution time which is time when the processing in accordance with the content of the process was executed to data obtained by execution of the processing in accordance with the content of the process;
a first obtaining unit configured to obtain the process content update time from the workflow definition file at the time of executing the processing in accordance with the content of the process of the workflow;
a second obtaining unit configured to obtain the process execution time added to data employed for the processing in accordance with the content of the process to be executed, by the adding unit; and
a canceling unit configured to cancel execution of the processing in accordance with the content of the process to be executed when the process content update time obtained by the first obtaining unit is later than the process execution time obtained by the second obtaining unit.

2. The workflow execution device according to claim 1, wherein the canceling unit cancels execution of the processing in accordance with the content of the process to be executed when the process content update time obtained by the first obtaining unit, of a process prior to the process to be executed, is later than the process execution time obtained by the second obtaining unit.

3. The workflow execution device according to claim 1, wherein said workflow definition file includes processing propriety information indicating the permission or denial of execution of the processing in accordance with the content of the process to be executed;
and wherein the canceling unit cancels execution of the processing in accordance with the content of the process to be executed when the process content update time obtained by the first obtaining unit is later than the process execution time obtained by the second obtaining unit, and also execution of the processing in accordance with the content of the process to be executed is not permitted with the processing propriety information.

4. The workflow execution device according to claim 3, wherein the processing propriety information is information indicating whether to permit execution of the processing in accordance with the content of the process to be executed, according to the progress of the workflow;
and wherein the canceling unit cancels execution of the processing in accordance with the content of the process to be executed when the process content update time obtained by the first obtaining unit is later than the process execution time obtained by the second obtaining unit, and also execution of the processing in accordance with the content of the process to be executed is not permitted with the processing propriety information as to the process to be executed.

5. The workflow execution device according to claim 1, further comprising:
an execution unit configured to execute alternative processing for the processing in accordance with the content of the process to be executed, according to the content of the process to be executed, if execution of the processing in accordance with the content of the process to be executed is canceled by the canceling unit.

6. The workflow execution device according to claim 1, further comprising:
an inquiring unit configured to inquire of a management server configured to manage the workflow whether to continue the processing in accordance with the content of the process;
wherein when receiving no response from the management server as to the inquiry by the inquiring unit, the first obtaining unit obtains the process content update time from the workflow definition file, and the second obtaining unit obtains the process execution time.

7. The workflow execution device according to claim 6, further comprising:
a storage unit configured to store execution result information relating to the results obtained by executing the processing in accordance with the content of the process of the workflow in a recording medium; and
a transmission unit configured to transmit the execution result information stored by the storage unit to the management server following no response being received as to the inquiry by the inquiring unit, and upon the response being resumed.

8. The workflow execution device according to claim 1, wherein upon the process execution time having been added to the data obtained by execution of the processing in accordance with the content of the process, the adding unit updates the process execution time to a new process execution time.

9. A workflow execution method to execute, based on a workflow definition file in which the contents of processes within a workflow, and process content update time which is time when the content of at least one of the processes was updated are set, the processes of the workflow, the method comprising:
adding, upon processing in accordance with the content of a process of the workflow being executed, process execution time which is time when the processing in accordance with the content of the process was executed to data obtained by execution of the processing in accordance with the content of the process;
obtaining the process content update time from the workflow definition file at the time of executing the processing in accordance with the content of the process of the workflow;
obtaining the process execution time added to data employed for the processing in accordance with the content of the process to be executed; and
discontinuing execution of the processing in accordance with the content of the process to be executed when the process content update time is obtained later than the process execution time obtained.

10. A computer-readable recording medium configured to store a program arranged to execute a workflow execution method to execute, based on a workflow definition file in which the contents of processes within a workflow, and process content update time which is time when the content of at least one of the processes was updated are set, the processes of the workflow, the method comprising:
adding, upon processing in accordance with the content of a process of the workflow being executed, process execution time which is time when the processing in accordance with the content of the process was executed to data obtained by execution of the processing in accordance with the content of the process;
obtaining the process content update time from the workflow definition file at the time of executing the processing in accordance with the content of the process of the workflow;
obtaining the process execution time added to data employed for the processing in accordance with the content of the process to be executed; and
discontinuing execution of the processing in accordance with the content of the process to be executed when the process content update time is obtained later than the process execution time obtained.
